(19) United States
(12) Patent Application Publication
(10) Pub. No.: US 2025/0335219 A1
(43) Pub. Date: Oct. 30, 2025

(54) ON-SCREEN APPLICATION OBJECT DETECTION

(71) Applicant: Soroco India Private Limited, Bengaluru (IN)

(72) Inventors: George Peter Nychis, Somerville, MA (US); Rohan Narayana Murty, Bangalore (IN); Wolfgang Richter, Arlington, MA (US)

(21) Appl. No.: 19/193,409

(22) Filed: Apr. 29, 2025

Related U.S. Application Data
(60) Provisional application No. 63/639,870, filed on Apr. 29, 2024.

(51) Int. Cl. G06F 9/451; G06F 11/34; G06V 10/70; G06V 30/30

(52) U.S. Cl. CPC G06F 9/451; G06F 11/3438; G06V 10/70; G06V 30/30

(57) ABSTRACT

A method of gathering information about a process being performed by a user of a computing device having application programs and separate monitoring software installed thereon is described. The user performs the process by performing actions via a sequence of application user interface (UI) screens. The method comprises capturing screenshots of at least some application UI screens in the sequence to obtain a sequence of application screenshots; processing the sequence of application screenshots using multiple different trained machine learning (ML) models to extract a corresponding sequence of application UI screen metadata, the multiple different trained ML models including an object detection model and a text recognition model; using the sequence of application UI screen metadata to generate a representation of the process; and storing the representation of the process on the computing device and/or transmitting the representation of the process to another device different from the computing device.

### RELATED APPLICATIONS

This application claims the benefit of U.S. Provisional Patent Application Ser. No. 63/639,870, filed Apr. 29, 2024, entitled “On-Screen Application Object Detection,” which is incorporated by reference herein in its entirety.

### BACKGROUND

Employees at many companies spend much of their time working on computers. An employer may monitor an employee's computer activity by installing a monitoring application program on the employee's work computer to monitor the employee's actions. For example, an employer may install a keystroke logger application on the employee's work computer. The keystroke logger application may be used to capture the employee's keystrokes and store the captured keystrokes in a text file for subsequent analysis.

### SUMMARY

Some embodiments provide for a method of gathering information about a process being performed by a user of a computing device, the computing device having application programs and separate monitoring software installed thereon, the user performing the process by performing a sequence of actions via a respective sequence of application user interface (UI) screens, and each of the application UI screens being generated by a respective one of the application programs. The method comprises using at least one computer hardware processor of the computing device to perform: (A) capturing screenshots of at least some application UI screens in the sequence of application UI screens to obtain a sequence of application screenshots including a first application screenshot, while the user is performing the process by performing the sequence of actions via the respective sequence application screens; (B) processing the sequence of application screenshots using multiple different trained machine learning (ML) models to extract a corresponding sequence of application UI screen metadata including first application UI screen metadata extracted from the first application screenshot, the multiple different trained ML models including an object detection model and a text recognition model, the processing comprising: generating a first image from the first application screenshot; detecting, using the object detection model, objects in the first image corresponding to graphical user interface (GUI) elements visible in the first application screenshot; and recognizing, using the text recognition model, text visible in at least some of the GUI elements visible in the first application screenshot, wherein the first application UI screen metadata comprises metadata about one or more of the GUI elements visible in the first application screenshot; (C) using the sequence of application UI screen metadata to generate a representation of the process being performed by the user; and (D) storing the representation of the process on the computing device and/or transmitting the representation of the process to another device different from the computing device.

Some embodiments provide for a system comprising a computing device having application programs and separate monitoring software installed thereon; and at least one non-transitory computer-readable storage medium having stored therein instructions which, when executed, program the computing device to perform a method of gathering information about a process being performed by a user of a computing device, the computing device having application programs and separate monitoring software installed thereon, the user performing the process by performing a sequence of actions via a respective sequence of application user interface (UI) screens, and each of the application UI screens being generated by a respective one of the application programs. The method comprises: (A) capturing screenshots of at least some application UI screens in the sequence of application UI screens to obtain a sequence of application screenshots including a first application screenshot, while the user is performing the process by performing the sequence of actions via the respective sequence application screens; (B) processing the sequence of application screenshots using multiple different trained machine learning (ML) models to extract a corresponding sequence of application UI screen metadata including first application UI screen metadata extracted from the first application screenshot, the multiple different trained ML models including an object detection model and a text recognition model, the processing comprising: generating a first image from the first application screenshot; detecting, using the object detection model, objects in the first image corresponding to graphical user interface (GUI) elements visible in the first application screenshot; and recognizing, using the text recognition model, text visible in at least some of the GUI elements visible in the first application screenshot, wherein the first application UI screen metadata comprises metadata about one or more of the GUI elements visible in the first application screenshot; (C) using the sequence of application UI screen metadata to generate a representation of the process being performed by the user; and (D) storing the representation of the process on the computing device and/or transmitting the representation of the process to another device different from the computing device.

Some embodiments provide for at least one non-transitory computer-readable storage medium having stored therein instructions which, when executed, program a computing device to perform a method of gathering information about a process being performed by a user of a computing device, the computing device having application programs and separate monitoring software installed thereon, the user performing the process by performing a sequence of actions via a respective sequence of application user interface (UI) screens, and each of the application UI screens being generated by a respective one of the application programs. The method comprises: (A) capturing screenshots of at least some application UI screens in the sequence of application UI screens to obtain a sequence of application screenshots including a first application screenshot, while the user is performing the process by performing the sequence of actions via the respective sequence application screens; (B) processing the sequence of application screenshots using multiple different trained machine learning (ML) models to extract a corresponding sequence of application UI screen metadata including first application UI screen metadata extracted from the first application screenshot, the multiple different trained ML models including an object detection model and a text recognition model, the processing comprising: generating a first image from the first application screenshot; detecting, using the object detection model, objects in the first image corresponding to graphical user interface (GUI) elements visible in the first application screenshot; and recognizing, using the text recognition model, text visible in at least some of the GUI elements visible in the first application screenshot, wherein the first application UI screen metadata comprises metadata about one or more of the GUI elements visible in the first application screenshot; (C) using the sequence of application UI screen metadata to generate a representation of the process being performed by the user; and (D) storing the representation of the process on the computing device and/or transmitting the representation of the process to another device different from the computing device.

Some embodiments provide for a method of gathering information about a process being performed by a user of a computing device, the computing device having application programs and separate monitoring software installed thereon, the user performing the process by performing a sequence of actions via a respective sequence of application user interface (UI) screens, and each of the application UI screens being generated by a respective one of the application programs. The method comprises using at least one computer hardware processor of the computing device to perform: (A) capturing screenshots of at least some application UI screens in the sequence of application UI screens to obtain a sequence of application screenshots including a first application screenshot, while the user is performing the process by performing the sequence of actions via the respective sequence application screens; and (B) processing the sequence of application screenshots using multiple different trained machine learning (ML) models to extract a corresponding sequence of application UI screen metadata including first application UI screen metadata extracted from the first application screenshot, the multiple different trained ML models including an object detection model and a text recognition model, the processing comprising: generating a first image from the first application screenshot; detecting, using the object detection model, objects in the first image corresponding to graphical user interface (GUI) elements visible in the first application screenshot; and recognizing, using the text recognition model, text visible in at least some of the GUI elements visible in the first application screenshot, wherein the first application UI screen metadata comprises metadata about one or more of the GUI elements visible in the first application screenshot.

Some embodiments provide for a system comprising a computing device having application programs and separate monitoring software installed thereon; and at least one non-transitory computer-readable storage medium having stored therein instructions which, when executed, program the computing device to perform a method of gathering information about a process being performed by a user of a computing device, the computing device having application programs and separate monitoring software installed thereon, the user performing the process by performing a sequence of actions via a respective sequence of application user interface (UI) screens, and each of the application UI screens being generated by a respective one of the application programs. The method comprises: (A) capturing screenshots of at least some application UI screens in the sequence of application UI screens to obtain a sequence of application screenshots including a first application screenshot, while the user is performing the process by performing the sequence of actions via the respective sequence application screens; and (B) processing the sequence of application screenshots using multiple different trained machine learning (ML) models to extract a corresponding sequence of application UI screen metadata including first application UI screen metadata extracted from the first application screenshot, the multiple different trained ML models including an object detection model and a text recognition model, the processing comprising: generating a first image from the first application screenshot; detecting, using the object detection model, objects in the first image corresponding to graphical user interface (GUI) elements visible in the first application screenshot; and recognizing, using the text recognition model, text visible in at least some of the GUI elements visible in the first application screenshot, wherein the first application UI screen metadata comprises metadata about one or more of the GUI elements visible in the first application screenshot.

Some embodiments provide for at least one non-transitory computer-readable storage medium having stored therein instructions which, when executed, program a computing device to perform a method of gathering information about a process being performed by a user of a computing device, the computing device having application programs and separate monitoring software installed thereon, the user performing the process by performing a sequence of actions via a respective sequence of application user interface (UI) screens, and each of the application UI screens being generated by a respective one of the application programs. The method comprises: (A) capturing screenshots of at least some application UI screens in the sequence of application UI screens to obtain a sequence of application screenshots including a first application screenshot, while the user is performing the process by performing the sequence of actions via the respective sequence application screens; and (B) processing the sequence of application screenshots using multiple different trained machine learning (ML) models to extract a corresponding sequence of application UI screen metadata including first application UI screen metadata extracted from the first application screenshot, the multiple different trained ML models including an object detection model and a text recognition model, the processing comprising: generating a first image from the first application screenshot; detecting, using the object detection model, objects in the first image corresponding to graphical user interface (GUI) elements visible in the first application screenshot; and recognizing, using the text recognition model, text visible in at least some of the GUI elements visible in the first application screenshot, wherein the first application UI screen metadata comprises metadata about one or more of the GUI elements visible in the first application screenshot.

### BRIEF DESCRIPTION OF DRAWINGS

Various non-limiting embodiments of the technology will be described with reference to the following figures. It should be appreciated that the figures are not necessarily drawn to scale.

FIG. 1A is a block diagram including components of a process tracking system, according to some embodiments of the technology described herein;

FIG. 1B is a diagram depicting identification of attributes by a process discovery process, according to some embodiments of the technology described herein;

FIG. 1C describes an example of process discovery, according to some embodiments of the technology described herein;

FIG. 1D illustrates an example user interface configured to display information regarding discovered instances of processes, according to some embodiments of the technology described herein;

FIG. 2A illustrates an example user interface screen that a user may interact with, according to some embodiments of the technology described herein;

FIG. 2B illustrates examples of attributes identified for the user interface screen of FIG. 2A, according to some embodiments of the technology described herein;

FIG. 3 illustrates a flowchart of acts for gathering information about a process being performed by a user of a computing device, according to some embodiments of the technology described herein;

FIG. 4 illustrates a block diagram depicting components of a metadata extraction system of the process tracking system of FIG. 1A, according to some embodiments of the technology described herein;

FIG. 5 illustrates example objects detected in a screenshot of an application user interface screen by an object detection module of the metadata extraction system, according to some embodiments of the technology described herein;

FIGS. 6A-6B illustrate example annotated screenshots used for training an object detection model, according to some embodiments of the technology described herein.

FIG. 7 is a block diagram of an example pipeline used to train an object detection model, according to some embodiments of the technology described herein.

FIG. 8 illustrates a flowchart of an illustrative method for generating a textual summary of a stream of events corresponding to interactions between a user performing a process and one or more application programs executing on a computing device, in accordance with some aspects of the technology described herein.

FIG. 9A-9D are block diagrams showing various embodiments for using machine learning models to generate textual summaries of events, in accordance with some aspects of the technology described herein.

FIG. 10 schematically illustrates components of a computer that may be used to implement some embodiments described herein.

### DETAILED DESCRIPTION

Aspects of the technology described herein relate to improvements in robotic process automation technology. Generally, robotic process automation involves two stages: (1) an information gathering stage that involves identifying computerized processes being performed by one or more users; and (2) an automation stage that involves automating these processes through software programs, sometimes referred to as “software robots,” which can perform the identified processes more efficiently thereby assisting the users and/or freeing them up to attend to other work.

In the automation stage, in some embodiments, the information collected during the information gathering stage may be employed to create software robot computer programs (hereinafter, “software robots”) that are configured to programmatically control one or more other computer programs (e.g., one or more application programs and/or one or more operating systems) to perform one or more tasks at least in part via the graphical user interfaces (GUIs) and/or application programming interfaces (APIs) of the other computer program(s). For example, an automatable task may be identified from the data collected during the information gathering stage and a software developer may create a software robot to perform the automatable task. In another example, all or any portion of a software robot configured to perform the automatable task may be automatically generated by a computer system based on the collected computer usage information. Some aspects of software robots are described in U.S. Pat. No. 10,474,313, titled “SOFTWARE ROBOTS FOR PROGRAMMATICALLY CONTROLLING COMPUTER PROGRAMS TO PERFORM TASKS,” granted on Nov. 12, 2019, filed on Mar. 3, 2016, which is incorporated herein by reference in its entirety.

Existing techniques utilized during the information gathering stage collect low-level data such as click and keystroke data from multiple users for a period of time and analyze that data to discern or discover, in these data, instances of one or more computerized processes being performed by the monitored users. This data is collected as the user interacts with multiple applications and is used to identify processes being performed by multiple users in an enterprise (e.g., a business having tens, hundreds, thousands or even tens of thousands of users). The collected data includes information regarding user interface elements that the user directly interacts with, such as, a particular button displayed via a user interface screen of an application that the user clicks on, a particular field displayed via a user interface screen of an application that the user types/enters data into, a particular drop-down menu displayed via a user interface screen of an application via which the user selects a option or value, and/or other user interactions. Some aspects of process discovery are described in U.S. Pat. No. 11,816,112, titled “SYSTEMS AND METHODS FOR AUTOMATED PROCESS DISCOVERY,” granted on Nov. 14, 2023, filed on Apr. 2, 2021, and U.S. Pat. No. 12,020,046, titled “SYSTEMS AND METHODS FOR AUTOMATED PROCESS DISCOVERY,” granted on Jun. 25, 2024, filed on Apr. 1, 2022, each of which is incorporated herein by reference in its entirety.

A process discovery software system can generate representations (e.g., numerical representation(s)) of a particular process which can be used to process the click and keystroke data to identify instances of that particular process being performed by one or more users. This may be done through a teaching mechanism in which the process discovery software is placed into a “teaching mode” and one or more users perform one or more instances of the particular process while the process discovery software is capturing low-level data as the user interacts with his/her computing device using multiple different application programs, user interfaces of the application program(s), and the buttons, fields, and other user interface elements therein. In turn, the taught process instances may be used to generate the numeric representation(s) of the process. The generated numeric representation(s) may be then used to discover, efficiently, other instances of the process from data collected by monitoring one or more other users (e.g., other users at an enterprise).

In some embodiments, the numeric representation(s) of a process may be compact and may contain a small amount of data relative to the data collected for a particular process instance. As a result, using the numeric representation(s) to identify process instances can be implemented efficiently, reducing the computational burden on the process discovery system. By contrast, recording a single process instance and attempting to correlate that process instance with volumes of data, would be computationally inefficient. In this sense, the techniques developed by the inventors provide an improvement to not only process discovery technology, but also to the functioning of a computer because they substantially reduce the amount of computational resources required to identify process instances while performing process discovery.

In turn, the discovered processes can be used in different ways. For example, one or more visualizations of the process discovery results may be displayed to a user (as shown, for example, in FIGS. 28, 29, and 32-24 of PCT Application PCT/IN2024/050370, titled “MACHINE LEARNING SYSTEMS AND METHODS FOR AUTOMATED PROCESS DISCOVERY,” filed on Apr. 10, 2024, which is incorporated by reference herein in its entirety). As another example, the discovered processes may be automatically evaluated for automating using software (e.g., creation of software robots for automating the entire or a portion of the discovered process). In some embodiments, an automatable task may be identified from the discovered processes and all or a portion of a software robot configured to perform the automatable task may be manually or automatically created. As such, the techniques developed by the inventors provide an improvement to not only process discovery technology but also robotic process automation technology that can utilize processes discovered by the process discovery technology.

While collection and analysis of click and keystroke data may enable discovery of some processes being performed by users, the inventors have recognized that process discovery techniques can be improved upon by collecting and analyzing additional information available via user interface screens of applications. Such additional information may be referred to as “Attributes” and may include information regarding user interface elements that are visible in the user interface screens, such as information regarding non-interactive user interface elements (e.g., user interface elements with which a user cannot interact because these elements cannot receive any input from a user) and/or information regarding user interface elements that the user does not interact directly with (e.g., user interface elements visible in the screen that the user could interact with but does not). The inventors have recognized various advantages of collecting and analyzing information regarding such “Attributes.” For instance, analyzing information regarding “Attributes” may, among other advantages, enable process discovery techniques to (i) determine a context associated with interface elements that the user is interacting with, (ii) differentiate between similar processes, (iii) identify work being performed across multiple sessions, multiple applications, and/or multiple users, and/or (iv) generate and provide intuitive visualizations of process discovery results and metrics. Some aspects of “Attributes” and techniques used for their collection are described in PCT publication WO2024/074891, titled “SYSTEMS and METHODS FOR IDENTIFYING ATTRIBUTES FOR PROCESS DISCOVERY,” filed Sep. 29, 2023, which is incorporated by reference herein in its entirety.

Application Programming Interface (API)-based techniques can be used for collecting information regarding “Attributes”. However, API-based techniques have some drawbacks and can be unreliable and resource intensive. For example, collecting information regarding “Attributes” in a single application user interface screen may require performing dozens of API calls, some of which may not return properly or may cause applications to hang or become slow. As another example, the API calls can request information from the application in memory, thereby consuming computational resources that the application itself needs to execute. As yet another example, users can navigate through applications very quickly which makes collecting “Attribute” information very difficult as an “Attribute” that was visible on the screen at the time of user interaction may no longer be visible or available (e.g. replaced by a different “Attribute) when an API call is made to collect information regarding it. Therefore, in some cases, the collected information can be stale or irrelevant.

For web applications rendered in browsers such as Google Chrome™, Firefox®, and Internet Explorer™, Document Object Model (DOM)-based techniques can also be used for collecting information regarding “Attributes”. Information regarding “Attributes” is collected by using network API requests sent to and/or received by the web browser. The entire DOM may be requested from the web browser or application and temporarily stored. Collecting and processing the DOM requires substantial storage and computational resources. Moreover, processing network API requests for entire DOMs can consume network resources resulting in increased latency.

While API-based and DOM-based techniques can collect large amounts of information and context associated with interface elements that the user is interacting with, the inventors have recognized various drawbacks of using these techniques, as described above and including—(i) reliability issues due to using APIs and their ability to return results consistently and in a timely manner which makes it difficult to ensure that all “Attribute” information is accurately collected; (ii) staleness issues due to using APIs where an API call collects stale information (e.g., information that is no longer visible); (iii) performance issues because using APIs or DOMs requires substantial storage, computational, and network resources thereby causing applications to slow down or hang while the API- or DOM-based processing takes place; (iv) completeness issues because reliability and staleness may prevent obtaining information regarding all of the “Attributes” on the screen; and (v) heterogeneity of various APIs that would have to be employed to collect information about processes involving multiple different applications which makes maintenance and upgrading of the data collection technology difficult.

The inventors have further recognized that although it is possible to use APIs and DOMs to collect “Attribute” information, it may be difficult to reliably represent what the user saw on their screen in an understandable way. For example, a user can click on an element at a screen coordinate of (30, 500), but identifying the associated name for the element can be challenging. Even though the name may be directly associated with the element that was interacted with (e.g., if the element was a button and the label on the button that represents the name of the button was ‘OK’), in many cases, parsing through information from the APIs or DOMs to relate a label to the element that was interacted with can be extremely difficult, time consuming, and resource intensive. Such parsing may be accomplished by communicating the UI screens from a computing device of the user to a remote device (such as, a server) that processes the UI screens to obtain “Attribute” information. The obtained “Attribute” information is then sent back to the computing device. Such back-and-forth communication can raise serious privacy concerns.

To address the shortcomings of the above-described data collection techniques, the inventors have developed a metadata extraction system that extracts metadata from application user interface (UI) screens by processing screenshots of the application UI screens (e.g., the UI screens that a user interacted with during performance of the process) using one or more machine learning models. The processing of the screenshots can be done during or after performance of the process. The machine learning model(s) may process visual information that was visible and available on the application UI screens at the time of the user's interactions with those screens. Using the techniques described herein metadata may be extracted from UI screens in real time (e.g., within 100 ms, 200 ms, 300 ms, 400 ms, 500 ms, 600 ms, 700 ms, 800 ms, 900 ms, 1 second, 2 seconds, 3 seconds, 4 seconds, or 5 seconds of the interaction between the user and the UI screen), ensuring that the information can be processed without reliability or staleness concerns. Additionally, the metadata extraction system can extract not only information regarding “Attributes” but also information regarding all objects (e.g., tables, tabs, text boxes, labels, panes, etc.) visible on the screen in a hierarchical manner regardless of whether they are interacted with or not (such as, a particular button or label being in a particular pane, and a particular label being associated with a particular input box).

In some embodiments, the machine learning models may include an object detection model and a text recognition model. The object detection model may be configured to detect objects in an application UI screenshot, where the objects correspond to graphical user interface (GUI) elements visible in the application UI screenshot (e.g., screen title, tabs, text boxes, active tabs, labels, vertical key-value pairs, grid titles, drop-down menus, tables, buttons, and grids, etc.). The text recognition model may be configured to recognize text visible in at least some of the GUI elements visible in the application screenshot (e.g. such as labels on buttons, names of fields, etc.). The results of the objects detection model and the text recognition model may be used to generate metadata for the application UI screenshot.

Given that the application of such machine learning models to application UI screenshots may be computationally demanding, one possible approach to obtaining real time performance would be to capture the screenshots on the user's device (i.e., the device with which the user is interacting to perform a process) and transmit them for processing by machine learning models on another device (e.g., a remote server). And, in some embodiments, this is a possible approach and implementation. However, the inventors have also recognized that application UI screens often contain various types of sensitive information including personally identifiable information (PII) such as, for example, usernames, addresses, financial data, medical data, etc. As a result, transmitting application screenshots to remote servers may make such sensitive information vulnerable to security attacks, may require additional expensive security measures at the remote servers, and/or may raise other similar privacy and data security issues.

Accordingly, to avoid such privacy issues with application screenshots (containing potentially sensitive information) being transmitted from the device on which they were captured, the inventors have developed various optimization techniques that allow for metadata extraction using machine learning (e.g., object detection and text recognition ML models) to be performed on the user's computing device and in real time. Any (e.g., one, some or all) of these optimization techniques may be employed. This way, the application screenshots need not be transferred from the device on which they were captured.

One such optimization technique, which may be used in some embodiments, involves extracting metadata in accordance with limits on utilization of computing device resource(s) specified by a resource utilization policy described in detail in section titled “Constraints” herein. This ensures that a substantially reduced amount of computational resources are utilized without interference with (e.g., causing delays to software executing on) the device with which the user is interacting when performing the process.

Another optimization technique, which may be used in some embodiments, involves caching, in volatile memory (i.e., a type of memory, for example RAM or CPU cache, that loses data stored on it when the power supply to the memory is interrupted) of the device with which the user is interacting, text strings recognized using the text recognition model corresponding to GUI elements visible in a first application screenshot. In turn, the cached text strings may be used to recognize text for at least some GUI elements in a second application screenshot that correspond to the GUI elements visible in the first application screenshot. Therefore, text recognition can be performed across multiple screenshots without running the text recognition model for every GUI element visible in each application screenshot of the multiple screenshots. This optimization may be very helpful when processing a sequence screenshots from the same application program because such screenshots will typically share many GUI elements and may, in fact, be quite similar to one another-caching text recognition results obtained from one screen to avoid repeating recognizing the same text on a different screen can substantially improve performance and significantly reduce the amount of time needed to extract metadata from application screens.

Yet another optimization technique, which may be used in some embodiments, involves performing text recognition on only those GUI elements that are identified as containing text by a text detection model resulting in computational savings relative to the approach in which text recognition would be performed on every single GUI element detected using the object detection model. That is because detecting whether a GUI element contains text (using a text detection machine learning model as described herein) but not recognizing this text requires less computation than recognizing the text contained in the GUI element. Accordingly, computational savings result by detecting GUI elements that contain text using a text detection model and then recognizing the text in only those GUI elements.

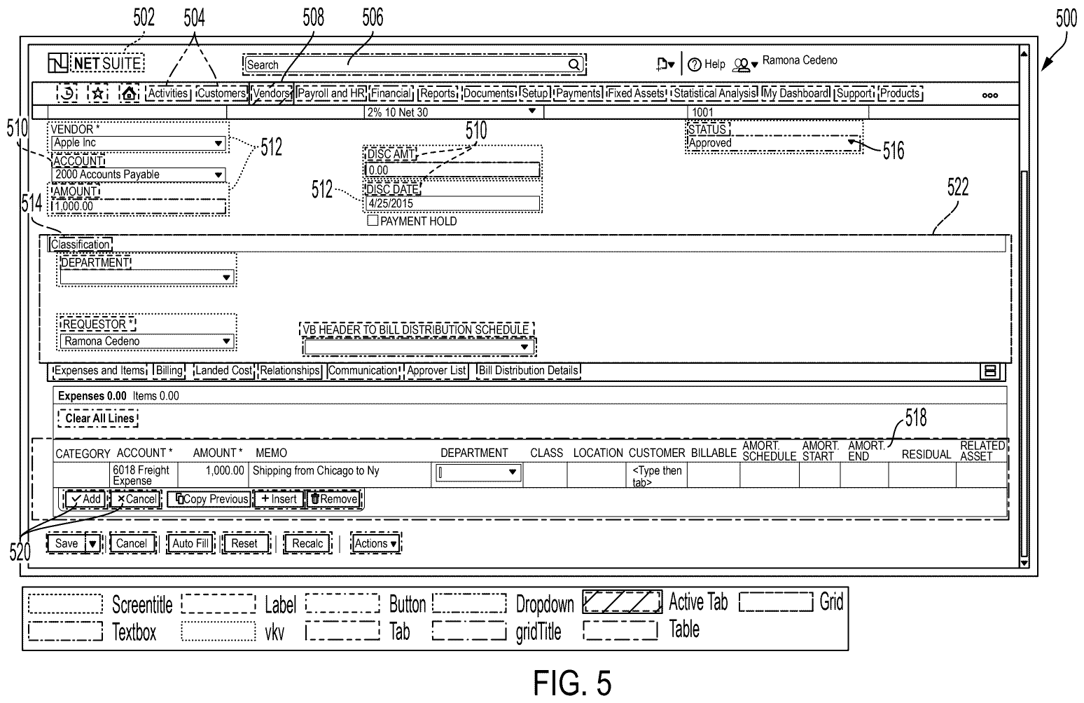

Accordingly, some embodiments provide for a method of gathering information about a process being performed by a user of a computing device, the computing device having application programs and separate monitoring software installed thereon, the user performing the process by performing a sequence of actions via a respective sequence of application user interface (UI) screens, each of the application UI screens being generated by a respective one of the application programs, the method comprising: (A) capturing screenshots of at least some application UI screens in the sequence of application UI screens to obtain a sequence of application screenshots including a first application screenshot, while the user is performing the process by performing the sequence of actions via the respective sequence application screens; (B) processing the sequence of application screenshots using multiple different trained machine learning (ML) models to extract a corresponding sequence of application UI screen metadata including first application UI screen metadata extracted from the first application screenshot, the multiple different trained ML models including an object detection model and a text recognition model, the processing comprising: (1) generating a first image from the first application screenshot; (2) detecting, using the object detection model, objects (e.g., objects 502, 504, 506, 508, 510, 512, 514, 516, 518, 520, and 522 shown in FIG. 5) in the first image corresponding to graphical user interface (GUI) elements visible in the first application screenshot; (3) recognizing, using the text recognition model, text visible in at least some of the GUI elements visible in the first application screenshot (e.g., “Activities” and “Customers” for objects 504 representing tabs), wherein the first application UI screen metadata comprises metadata (e.g., element name, element type, element value, location of the element on the screen, text visible in the element, the element's location in an object hierarchy, etc.) about one or more of the GUI elements visible in the first application screenshot; (C) using the sequence of application UI screen metadata to generate a representation of the process being performed by the user; and (D) storing the representation of the process on the computing device and/or transmitting the representation of the process to another device different from the computing device. Utilizing metadata extracted using the techniques described herein may increase the accuracy of a process discovery technique, which in turn improves the quality of software robots generated to automate the processes identified using the process discovery technique.

In some embodiments, the first application screenshot comprises a first GUI element, detecting, using the object detection model, objects in the first image corresponding to GUI elements visible in the first application screenshot comprises determining location of a first bounding box of the first GUI element in the first application screenshot, and recognizing, using the text recognition model, text visible in at least some of the GUI elements visible in the first application screenshot comprises recognizing first text visible in the first GUI element.

In some embodiments, the first application screenshot was generated by a first application program, the sequence of application screenshots includes a second application screenshot also generated by the first application program, and processing the sequence of application screenshots comprises: caching, in volatile memory of the computing device, text strings recognized using the text recognition model in association with information about the corresponding GUI elements visible in the first application screenshot; and accessing at least some of the text strings cached in the volatile memory of the computing device instead of using the text recognition model to recognize text in at least some GUI elements visible in the second application screenshot that correspond to the GUI elements visible in the first application screenshot. In this way, text recognition is not performed on each and every GUI element across multiple application screenshots, which would be computationally expensive, and wasteful since text visible in come GUI elements may not change across the multiple application screenshots. Instead, using a caching technique that caches text strings in volatile memory allows for text recognition to be performed across multiple screenshots without running the text recognition model for every GUI element visible in each application screenshot of the multiple application screenshots, resulting in computational savings relative to the approach in which text recognition would be performed on every GUI element visible in each application screenshot.

In some embodiments, the information about the corresponding GUI elements visible in the first application screenshot indicates locations of bounding boxes of the corresponding GUI elements, and caching the text strings is performed by caching the text strings using hashes of pixels in the bounding boxes as keys to the cache.

In some embodiments, the first application screenshot comprises a first GUI element, detecting, using the object detection model, objects in the first image corresponding to GUI elements visible in the first application screenshot comprises determining location of a first bounding box of the first GUI element in the first application screenshot, recognizing, using the text recognition model, text visible in at least some of the GUI elements visible in the first application screenshot comprises recognizing first text visible in the first GUI element, and caching the text strings comprises caching, in the volatile memory of the computing device, the first text string using a hash of pixels in the first bounding box as a key.

In some embodiments, the method further comprises flushing the cached text strings from the volatile memory when the first application program closes or restarts or according to a schedule.

In some embodiments, the method further comprises: prior to recognizing, using the text recognition model, text visible in the at least some of the GUI elements visible in the first application screenshot, using a text detection technique to identify the at least some of the GUI elements, from among the GUI elements visible in the first application screenshot for which objects were detected using the first trained ML model. In this way, text recognition is not performed on each and every GUI element, which would be computationally expensive, and wasteful since not all GUI elements contain text. Instead, using a text detection technique to identify GUI elements that contain text allows for performing text recognition only on those GUI elements that have been determined to contain text, resulting in computational savings relative to the approach in which text recognition would be performed on every GUI element detected using the object detection model.

In some embodiments, the method further comprises: accessing a configuration specifying a resource utilization policy applicable to the computing device, the resource utilization policy specifying limits on utilization of one or more computing device resources during performance of acts (A) and (B) by software executing on the computing device; and performing (A) and (B) in accordance with the limits specified by the resource utilization policy.

In some embodiments, the method further comprises: removing or masking personally-identifiable information (PII) in the sequence of application UI screen metadata prior to performing (C) and (D).

In some embodiments, act (B) comprises: organizing at least some of the objects detected using the object detection model into an object hierarchy; and including the object hierarchy as part of the first application UI screen metadata. Application UI screens are typically organized in a hierarchical manner with horizontal and vertical key-value pairs. For example, a text box may be inside a horizontal key-value pair or a vertical key-value pair. An object hierarchy captures such hierarchical information which can provide further context regarding user interactions. Including the object hierarchy in the UI screen metadata may be helpful in various downstream uses of the metadata, for example, in generating signatures of the process, detecting performance of the process in data collected from one or more other users, providing a high-level description (e.g., a textual summary) with business context of what interactions were performed by a user, etc.

In some embodiments, the object detection model is a trained convolutional neural network that is trained to detect objects in screenshots. In some embodiments, the method further comprises obtaining training data comprising a plurality of annotated screenshots of at least some the application UI screens; and using the training data to train the object detection model. In some embodiments, the object detection model comprises millions of parameter values (e.g., 5-10 million, 5-20 million, 10-25 million, 10-50 million, 5-500 million, or any range of parameter values within these ranges). In some embodiments, the object detection model comprises at least 7.5 million parameter values.

In some embodiments, the text recognition model comprises an optical character recognition model for translating the detected text into textual strings.

In some embodiments, generating the first image from the first application screenshot comprises: processing the first image using one or more pre-processing techniques, the one or more pre-processing techniques comprising one or more of gray scaling, sharpening, or color inversion techniques. In some embodiments, processing the first image using the one or more pre-processing techniques comprises: determining a first type of the one or more pre-processing techniques to use to process the first image based on a type of application program that generated an application UI screen for which the first application screenshot was captured. In some embodiments, the type of application program or name of the application program may be determined using OS-specific and/or image processing APIs.

In some embodiments, the GUI elements visible in the first application screenshot comprise one or more of the following: a screen title, an active tab, a tab, a horizontal key-value pair, a vertical key-value pair, an address bar, a drop-down menu, a text box, a table, a label, an overlay, a header, an icon, a check box, a radio button, and a button.

In some embodiments, the first application UI screen metadata comprises: a hierarchy of the one or more of the GUI elements visible in the first application screenshot, and for each of the one or more of the GUI elements, an element name, an element type, and an element value.

In some embodiments, the method further comprises using the representation of the process to discover the process during performance of a second sequence of actions by the user via a respective second sequence of application UI screens.

In some embodiments, the method further comprises generating, using the representation of the process, a visualization of at least some of the sequence of actions.

In some embodiments, the method further comprises identifying an automatable task using the representation of the process; and generating a software robot to perform the automatable task.

Some embodiments provide for a method of gathering information about a process being performed by a user of a computing device, the computing device having application programs and separate monitoring software installed thereon, the user performing the process by performing a sequence of actions via a respective sequence of application user interface (UI) screens, and each of the application UI screens being generated by a respective one of the application programs. The method comprises using at least one computer hardware processor of the computing device to perform: (A) capturing screenshots of at least some application UI screens in the sequence of application UI screens to obtain a sequence of application screenshots including a first application screenshot, while the user is performing the process by performing the sequence of actions via the respective sequence application screens; and (B) processing the sequence of application screenshots using multiple different trained machine learning (ML) models to extract a corresponding sequence of application UI screen metadata including first application UI screen metadata extracted from the first application screenshot, the multiple different trained ML models including an object detection model and a text recognition model, the processing comprising: generating a first image from the first application screenshot; detecting, using the object detection model, objects in the first image corresponding to graphical user interface (GUI) elements visible in the first application screenshot; and recognizing, using the text recognition model, text visible in at least some of the GUI elements visible in the first application screenshot, wherein the first application UI screen metadata comprises metadata about one or more of the GUI elements visible in the first application screenshot.

In some embodiments, the first application screenshot comprises a first GUI element, detecting, using the object detection model, objects in the first image corresponding to GUI elements visible in the first application screenshot comprises determining location of a first bounding box of the first GUI element in the first application screenshot, and recognizing, using the text recognition model, text visible in at least some of the GUI elements visible in the first application screenshot comprises recognizing first text visible in the first GUI element.

In some embodiments, the first application screenshot was generated by a first application program, the sequence of application screenshots includes a second application screenshot also generated by the first application program, and processing the sequence of application screenshots comprises: caching, in volatile memory of the computing device, text strings recognized using the text recognition model in association with information about the corresponding GUI elements visible in the first application screenshot; and accessing at least some of the text strings cached in the volatile memory of the computing device instead of using the text recognition model to recognize text in at least some GUI elements visible in the second application screenshot that correspond to the GUI elements visible in the first application screenshot.

In some embodiments, the information about the corresponding GUI elements visible in the first application screenshot indicates locations of bounding boxes of the corresponding GUI elements, and caching the text strings is performed by caching the text strings using hashes of pixels in the bounding boxes as keys to the cache.

In some embodiments, the first application screenshot comprises a first GUI element, detecting, using the object detection model, objects in the first image corresponding to GUI elements visible in the first application screenshot comprises determining location of a first bounding box of the first GUI element in the first application screenshot, recognizing, using the text recognition model, text visible in at least some of the GUI elements visible in the first application screenshot comprises recognizing first text visible in the first GUI element, and caching the text strings comprises caching, in the volatile memory of the computing device, the first text string using a hash of pixels in the first bounding box as a key.

In some embodiments, the method further comprises flushing the cached text strings from the volatile memory when the first application program closes or restarts or according to a schedule.

In some embodiments, the method further comprises prior to recognizing, using the text recognition model, text visible in the at least some of the GUI elements visible in the first application screenshot, and using a text detection technique to identify the at least some of the GUI elements, from among the GUI elements visible in the first application screenshot for which objects were detected using the object detection model.

In some embodiments, the method further comprises accessing a configuration specifying a resource utilization policy applicable to the computing device, the resource utilization policy specifying limits on utilization of one or more computing device resources during performance of acts (A) and (B) by software executing on the computing device; and performing (A) and (B) in accordance with the limits specified by the resource utilization policy.

In some embodiments, performing (B) further comprises organizing at least some of the objects detected using the object detection model into an object hierarchy; and including the object hierarchy as part of the first application UI screen metadata.

In some embodiments, the object detection model is a trained convolutional neural network that is trained to detect objects in screenshots.

In some embodiments, the method further comprises obtaining training data comprising a plurality of annotated screenshots of at least some the application UI screens; and using the training data to train the object detection model.

In some embodiments, the text recognition model comprises an optical character recognition model for recognizing text strings visible in the at least some of the GUI elements.

In some embodiments, generating the first image from the first application screenshot comprises processing the first image using one or more pre-processing techniques, the one or more pre-processing techniques comprising one or more of gray scaling, sharpening, and color inversion techniques.

In some embodiments, processing the first image using the one or more pre-processing techniques comprises determining a first type of the one or more pre-processing techniques to use to process the first image based on a type of application program that generated an application UI screen for which the first application screenshot was captured.

In some embodiments, the GUI elements visible in the first application screenshot comprise one or more of the following: a screen title, an active tab, a tab, a horizontal key-value pair, a vertical key-value pair, an address bar, a drop-down menu, a text box, a table, a label, an overlay, a header, an icon, a check box, a radio button, and a button.

In some embodiments, the first application UI screen metadata comprises a hierarchy of the one or more of the GUI elements visible in the first application screenshot, and for each of the one or more of the GUI elements, an element name, an element type, and an element value.

In some embodiments, the method further comprises using the sequence of application UI screen metadata to generate a representation of the process being performed by the user; and storing the representation of the process on the computing device and/or transmitting the representation of the process to another device different from the computing device.

In some embodiments, the method further comprises using the representation of the process to discover the process during performance of a second sequence of actions by the user via a respective second sequence of application UI screens.

In some embodiments, the method further comprises generating, using the representation of the process, a visualization of at least some of the sequence of actions.

In some embodiments, the method further comprises identifying an automatable task using the representation of the process; and generating a software robot to perform the automatable task.

In some embodiments, the method further comprises receiving information corresponding to the stream of events corresponding to the interactions between the user and one or more of the application programs, the information comprising, for each of multiple events in the stream of events associated with the process, metadata associated with the event, wherein the event corresponds to an interaction between the user an application program, wherein metadata associated with the event includes application UI screen metadata values obtained by performing (B) on an application screenshot of the application program, the application screenshot captured during the interaction between the user and the application program; processing, using at least one machine learning (ML) model, the metadata associated with the multiple events in the stream of events to generate multiple corresponding textual summaries of the multiple events, the processing comprising: for each particular event of the multiple events in the stream of events: processing metadata associated with the particular event using the at least one ML model to determine a business object, an activity, an intent, and/or a reason associated with the particular event; and generating a textual summary of the particular event from the determined business object, activity, intent, and/or reason associated with the particular event; and generating, using the textual summaries of the multiple events, a textual summary of the process performed by the user through the interactions between the user and the one or more of the application programs; and outputting the textual summary of the process.

In some embodiments, the at least one ML model consists of a single ML model; and processing the metadata associated with the particular event comprises processing the metadata associated with the particular event using the single ML model to determine the business object, the activity, the intent, and/or the reason associated with the particular event.

In some embodiments, the at least one ML model comprises a first ML model and a second ML model different from the first ML model; and processing the metadata associated with the particular event comprises: processing the metadata associated with the particular event using the first ML model to determine the business object associated with the particular event; and processing the metadata associated with the particular event using the second ML model to determine the activity associated with the particular event.

In some embodiments, the at least one ML model comprises a third ML model different from the first and second ML models and a fourth ML model different from the first, second, and third ML model; and processing the metadata associated with the particular event comprises: processing the metadata associated with the particular event using the third ML model to determine the intent associated with the particular event; and processing the metadata associated with the particular event using the fourth ML model to determine the reason associated with the particular event.

In some embodiments, the at least one ML model comprises a large language model (LLM), and the LLM is selected from the group consisting of: Llama3, Llama 2, Mistral, GPT-3, GPT-4, Bidirectional encoder representations from transformers (BERT), and Orca.

In some embodiments, the at least one ML model comprises a large language model; and processing metadata associated with the particular event using the at least one ML model comprises prompting the large language model with a natural language representation of the metadata associated with the particular event.

In some embodiments, the method comprises processing the metadata associated with the particular event using the at least one ML model to determine the activity associated with the particular event.

In some embodiments, the textual summary of the particular event comprises a natural language summary of the particular event and the textual summary of the process comprises a natural language summary of the process.

In some embodiments, generating the textual summary of the process comprises grouping two or more events in the multiple events into a step; generating a textual summary of the step using the textual summaries of the two or more events; and generating the textual summary of the process using the textual summary of the step.

In some embodiments, grouping the two or more events comprises grouping, using a large language model, the two or more events into the step.

In some embodiments, the method further comprises identifying, using the determined business object, activity, intent, and/or reason, the process in a second stream of events corresponding to interactions between the user and one or more of the application programs.

It should be appreciated that the embodiments described herein may be implemented in any of numerous ways. Examples of specific implementations are provided below for illustrative purposes only. It should be appreciated that these embodiments and the features/capabilities provided may be used individually, all together, or in any combination of two or more, as aspects of the technology described herein are not limited in this respect.

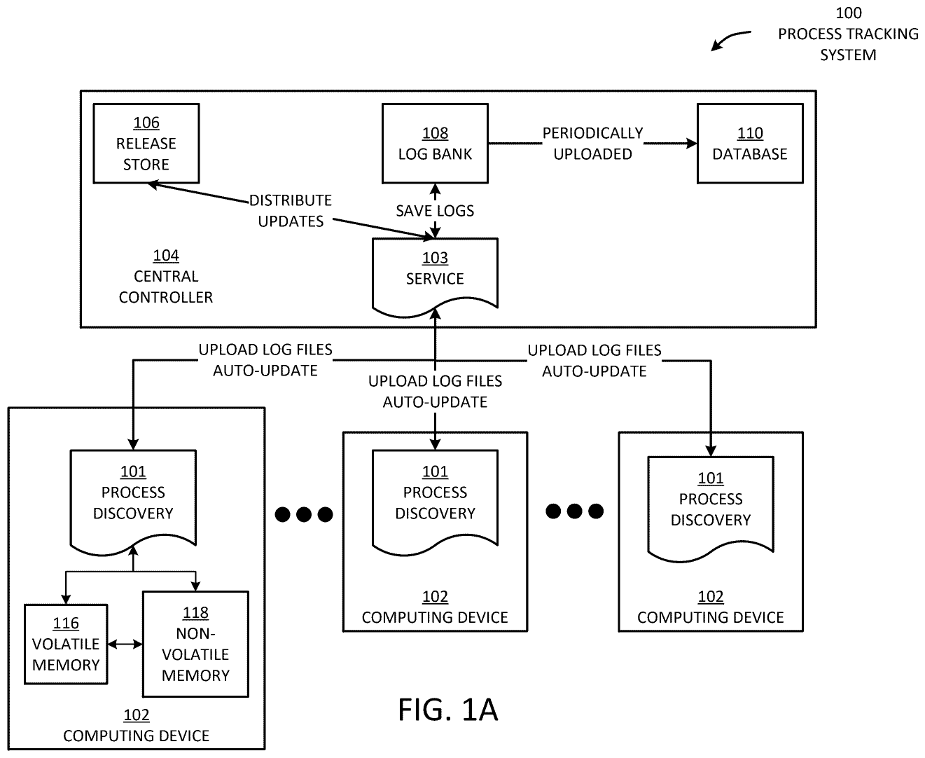

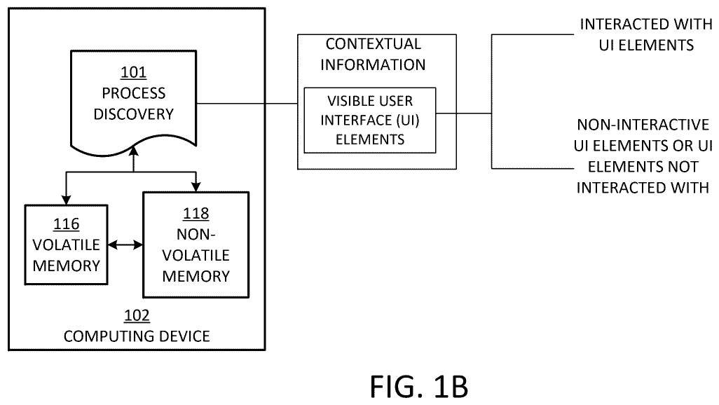

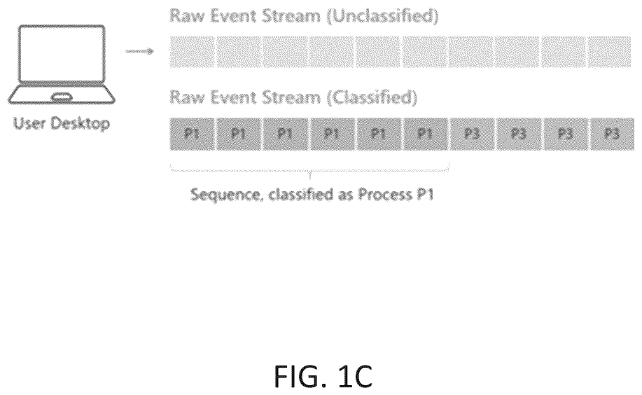

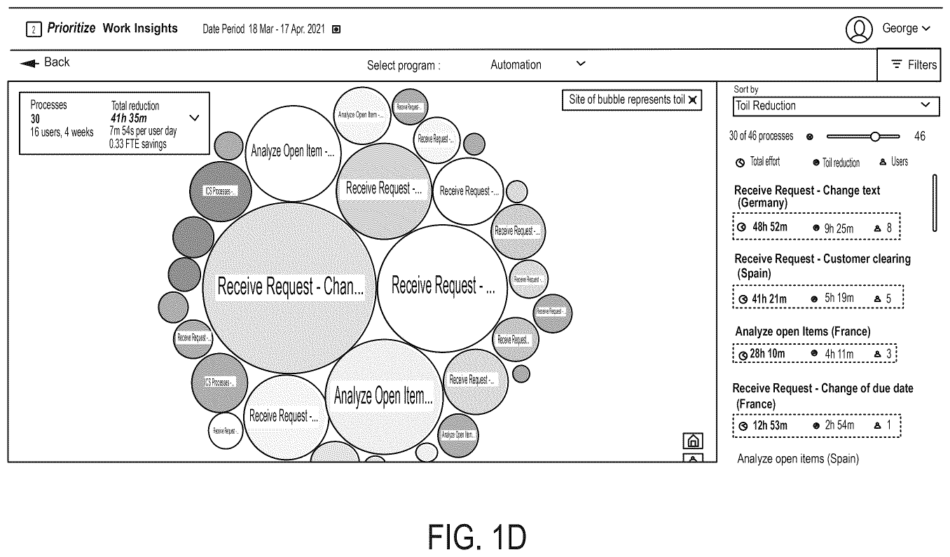

FIG. 1A shows an example process tracking system 100, according to some embodiments. The process tracking system 100 is suitable to track one or more processes being performed by users on a plurality of computing devices 102. Each of the computing devices 102 may comprise a volatile memory 116 and a non-volatile memory 118. At least some of the computing devices may be configured to execute process discovery module 101 (also referred to herein as “Scout™” that tracks user interaction with the respective computing device 102. Process discovery module 101 may be, for example, implemented as a software application and installed on an operating system, such as the WINDOWS® operating system, running on the computing device 102. In another example, process discovery module 101 may be integrated into the operating system running on the computing device 102. In some implementations, process discovery module 101 may include monitoring software installed on computing device 102.

As shown in FIG. 1A, process tracking system 100 further includes a central controller 104 that may be a computing device, such as a server, including a release store 106, a log bank 108, and a database 110. The central controller 104 may be configured to execute a service 103 that gathers the computer usage information collected from the process discovery modules 101 executing on the computing devices 102 and store the collected information in the database 110. Service 103 may be implemented in any of a variety of ways including, for example, as a web-application. In some embodiments, service 103 may be a Python Web Server Gateway Interface (WSGI) application that is exposed as a web resource to the process discovery modules 101 running on the computing devices 102.

In some embodiments, process discovery module 101 may monitor the particular tasks being performed on the computing device 102 on which it is running. For example, process discovery module 101 may monitor the task being performed by monitoring actions, such as keystrokes and/or clicks and gathering contextual information associated with each keystroke and/or click. The contextual information may include information indicative of the state of the user interface when the keystroke and/or click occurred. For example, the contextual information may include information regarding a state of the user interface such as the name of the particular application that the user interacted with, the particular button or field that the user interacted with, and/or the uniform resource locator (URL) link in an active web-browser. The contextual information may be leveraged to gain insight regarding the particular task that the user is performing. For example, a software developer may be using computing device 102 to develop source code and may be continuously switching between an application suitable for developing source code and a web-browser to locate code snippets. Unlike traditional keystroke loggers that would merely gather a string of depressed keys including bits of source code and web URLs, process discovery module 101 may advantageously gather useful contextual information such as the particular active application associated with each keystroke. Thereby, the task of developing source code may be more readily identified in the collected data by analyzing the active applications.

The data collection processes performed by process discovery module 101 may be seamless to a user of the computing device 102. For example, process discovery module 101 may gather the computer usage data without introducing a perceivable lag to the user between when one or more actions of a process are performed and when the user interface is updated. Further, process discovery module 101 may automatically store the collected computer usage data in the volatile memory 116 and periodically (or aperiodically or according to a pre-defined schedule) transfer portions of the collected computer usage data from the volatile memory 116 to the non-volatile memory 118. Thereby, process discovery module 101 may automatically upload captured information in the form of log files from the non-volatile memory 118 to service 103 and/or receive updates from service 103. Accordingly, process discovery module 101 may be completely unobtrusive on the user experience.

In some embodiments, the process discovery module 101 running on each computing device 102 may upload log files to service 103 that include computer usage information such as information indicative of one or more actions performed by a user on the respective computing device 102 and contextual information associated with those actions. Service 103 may, in turn, receive these log files and store the log files in the log bank 108. Service 103 may also periodically upload the logs in the log bank 108 to a database 110. It should be appreciated that the database 110 may be any type of database including, for example, a relational database such as PostgreSQL. Further, the events stored in the database 110 and/or the log bank 108 may be stored redundantly to reduce the likelihood of data loss from, for example, equipment failures. The redundancy may be added by, for example, by duplicating the log bank 108 and/or the database 110.

In some embodiments, service 103 may distribute updates (e.g., software updates) to the process discovery modules 101 running on each of the computing devices 102. For example, process discovery module 101 may request information regarding the latest updates that are available. In this example, service 103 may respond to the request by reading information from the release store 106 to identify the latest software updates and provide information indicative of the latest update to the process discovery module 101 that issued the request. If the process discovery module 101 returns with a request to download the latest version, the service 103 may retrieve the latest update from the release store 106 and provide the latest update to the process discovery module 101 that issued the request.

In some embodiments, service 103 may implement various security features to ensure that the data that passes between service 103 and one or more process discovery modules 101 is secure. For example, a Public Key Infrastructure may be employed by which process discovery module 101 may authenticate itself using a client certificate to access any part of the service 103. Further, the transactions between process discovery module 101 and service 103 may be performed over HTTPS and thus encrypted.

In some embodiments, service 103 makes the collected computer usage information in the database 110 and/or information based on the collected computer usage information (e.g., quality of attributes, user-level data indicative of how long it takes various users to perform the process, how many times the process is performed across a large organization, and/or other information) available to users. For example, service 103 (or some other component in communication with service 103) may be configured to provide a visual representation of at least some of the information stored in the database 110 and/or information based on the stored information to one or more users (e.g., of computing devices 102). For example, a series of user interface screens that permit a user to interact with the computer usage data in the database 110 and/or information based on the stored computer usage data may be provided as the visual representation. These user interface screens may be accessible over the Internet using, for example, HTTPS. It should be appreciated that service 103 may provide access to the data in the database 110 through still yet other ways. For example, service 103 may accept queries through a command-line interface (CLI), such as psql, or a graphical user interface (GUI), such as pgAdmin.

A “process” as that term is used herein, refers to a plurality of user actions that are collectively performed to achieve a task. The task may be any suitable task that could be performed by a user (or multiple users) by interacting with one or more computing devices. The task, in some embodiments, may be any suitable task that one or more users perform in a business such as, for example, one or more accounting, finance, IT, human resources, purchasing, and/or any other types of tasks. For example, a process may refer to a plurality of user actions that a user takes to perform the task of receiving a purchase order, reviewing the purchase order, and approving the purchase order. As another example, a process may refer to a plurality of user actions that a user takes to perform the task of opening an IT ticket for an issue (e.g., resetting a user's password), addressing the issue, and closing same (e.g., by resetting the password and notifying the user whose password was reset that this is completed). Some processes may include only a few (e.g., 2 or 3) user actions, whereas other processes may include more (e.g., tens, hundreds, or thousands) user actions.

A user may perform actions of a computerized process by interacting with the one or more application program(s). The application program(s) may be installed on a computing device to which the user has access (e.g., the user's desktop, laptop, smartphone, tablet, or other computing device). A user may interact with an application program through its user interface (e.g., a graphical user interface) by performing various acts via GUI elements shown on application UI screens of the UI interface. Examples of such acts include selecting checkboxes or radio buttons, entering information into fields, clicking on buttons, clicking on text, selecting text, cutting and/or pasting, clinking on links, dragging and dropping, moving, resizing, opening and/or closing a window, etc. A user may perform low-level acts (e.g., mouse clicks, keystrokes, button presses).

As described herein, a process is a unit of discovery that is searched for during “process discovery” to identify instances of the process in data other than training data, often referred to herein as “wild data” or “data in the wild.” In some embodiments, the “wild data” may be data captured during interaction between users and their computing devices. The data captured may include keystrokes, mouse clicks, and associated metadata (e.g., contextual information). In turn, the captured data may be analyzed using process discovery techniques to identify instances of one or more processes being performed by the users. Aspects of collecting data as the user interacts with a computing device and the types of data that may be captured are provided herein and in U.S. Pat. No. 10,831,450, titled “SYSTEMS AND METHODS FOR DISCOVERING AUTOMATABLE TASKS,” granted on Nov. 10, 2020, which is incorporated by reference herein in its entirety. Examples of collected contextual information may include, but not be limited to: Application (e.g., the name of an application, such as an operating system (e.g., Microsoft Windows, Mac OS, Linux), an application executing in the operating system, a web application, or a mobile application); Screen Title (e.g., the title appearing on the application such as the name of the tab in a web browser, the name of a file open in an application, etc.); Element Type (e.g., the type of a user interface element of the application that the user interacted with, such as “button”, “input”, “dropdown”, etc.); Element Name (e.g., the name of a user interface element of the application that the user interacted with such as a name of a button, label of input, etc.); and Element Value (e.g., the value in the user interface element of the application that the user interacted with such as, value “100 Acme drive” in an element that represents the address).

Some embodiments relate to using user interaction information collected via one or more process discovery modules 101 to generate numeric representation(s) of a process that can then be used to identify instances of the process from captured data corresponding to further user interaction information collected via the one or more of the process discovery modules.

Various components in process tracker system 100 may be used to perform generation of numeric representation(s) in teaching mode and/or process discovery. In some embodiments, process discovery may be performed locally on individual computing devices 102 by process discovery modules 101, which may be updated with the most recent numeric representation(s) stored centrally by service 103 periodically, aperiodically or in response to a request from the computing device to provide an update. In some embodiments, process discovery may be performed centrally, with data collected by process discovery modules 101 executing on computing devices 102 being forwarded to service 103, and with service 103 performing process discovery on the received data (from computing devices 102) using the numeric representation(s). In some embodiments, process discovery results may be analyzed using one or more software tools as described herein, and the software tools may execute locally on one or more computing device(s) 102, centrally as part of service 103, and/or in any suitable combination of local and centralized processing. Regardless of whether process discovery is performed locally, centrally, or in a combination of local and central processing, in some embodiments, process discovery results may be analyzed by any user.

In some embodiments, the discovered processes may be automatically evaluated for automating using software (e.g., creation of software robots for automating the entire or a portion of the discovered process). In some embodiments, an automatable task may be identified from the discovered processes and all or a portion of a software robot configured to perform the automatable task may be automatically created by the process tracking system 100.

In some embodiments, the process tracking system 100 may identify an automatable task based on an automation score generated by analyzing metadata (for example, including the application UI screen metadata described herein) associated with actions or events in the discovered processes. For example, the metadata may be analyzed to determine values for one or more parameters that impact automatability of a given task. Example parameters include but are not limited to, a number of applications employed to perform a task, a number of keystrokes performed in the task, a ratio between keystrokes and clicks performed in the task, and/or other parameters. In some embodiments, the process tracking system 100 may generate the automation score by combining (e.g., linearly combining) the values of these parameters. A determination may be made regarding whether the automation score exceeds a threshold. For example, a task with an automation score that exceeds the threshold may be a good candidate for automation. In response to a determination that the automation score exceeds a threshold, a software robot may be generated to perform the automatable task. Aspects of generating an automation score are described in U.S. Pat. No. 10,831,450, titled “SYSTEMS AND METHODS FOR DISCOVERING AUTOMATABLE TASKS,” granted on Nov. 10, 2020, which is incorporated by reference herein in its entirety.

In some embodiments, a software robot that is configured to perform the automatable task may be generated. The software robot may be configured to control the same set of one or more computer programs employed in the task. The software robot may be generated in any of a variety of ways. In some embodiments, the software robot may be generated using, for example, a sequence of one or more events defining the automatable task. For example, the process tracking system 100 may comprise one or more predetermined software routines for replicating one or more events and the process tracking system 100 may combine these software routines in accordance with the defined sequence of events associated with the task to form a software robot that is configured to perform the task.

In some embodiments, as shown in FIG. 1B, process discovery module 101 may collect action information associated with zero, one or more actions (e.g., a keystroke and/or a click) performed by the user via an application user interface (UI) screen generated by an application program, such as a business application, a desktop application, the Internet Browser, an Operating System, or any other computer software programs executing on computing device 102. In some instances, the process discovery module 101 may consider zero action to be performed when interaction with a graphical user element (GUI) element on a first application UI screen causes a second application UI screen to be presented rather than causing a particular action to be performed on the first application UI screen.

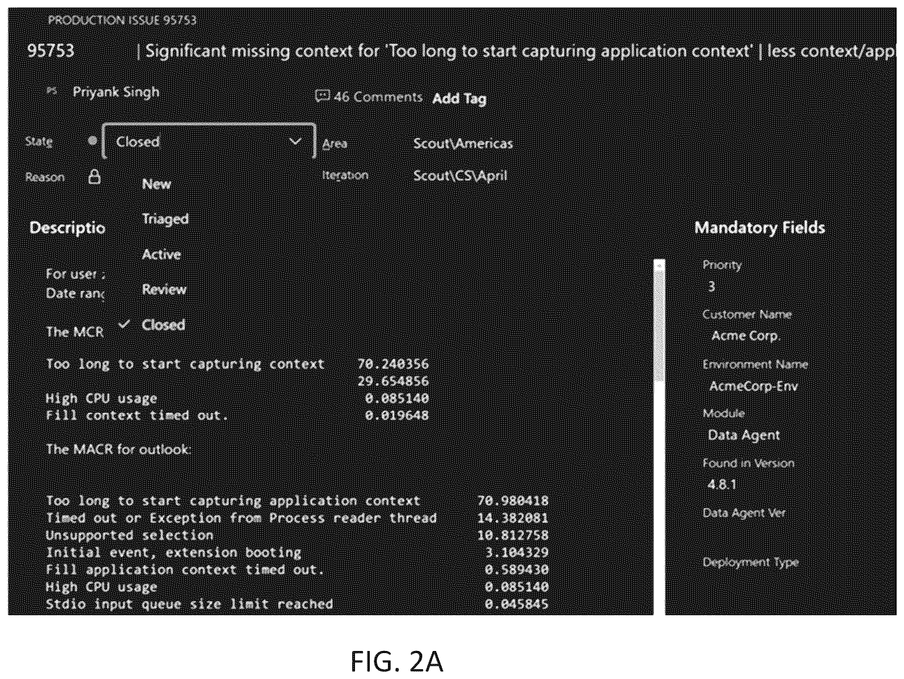

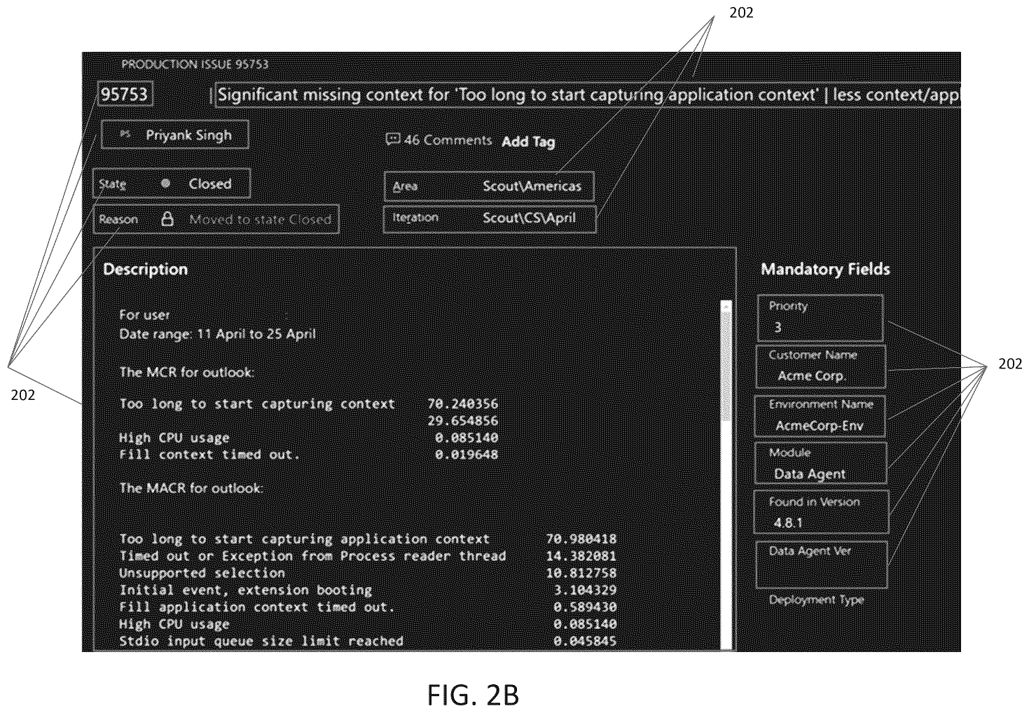

The process discovery module 101 may also collect contextual information associated with GUI elements that are visible in the application UI screen. These GUI elements may include elements, such as buttons or menus that the user interacts with and/or elements, such as fields or labels that the user does not interact with. In some embodiments, the process discovery module 101 may collect contextual information associated with GUI elements not visible in a UI screen. The contextual information may be analyzed to identify a number of attributes for the application UI screen. Each attribute may correspond to at least one GUI element visible in the application UI screen. An example application UI screen that a user may interact with is shown in FIG. 2A. FIG. 2B shows examples of various attributes 202 that may be identified by process discovery module 101. While in some embodiments, contextual information associated with visible GUI elements is collected, in other embodiments, contextual information associated with visible and invisible UI elements may be collected.

As depicted in FIG. 1C, process discovery technology may collect a raw event stream from the user's interactions with applications on their desktop, and then, classify the individual events into sequences of processes such as P1 and P3. All users in a team may have the events in their day classified to processes that they defined in their process catalogue and taught examples of. Once the user's days and their activities are classified into processes, the process discovery technology can provide statistics about the processes the users follow. This includes but is not limited to how many users conduct each business process, how many times they conduct it a day, the exact steps they follow and how those steps differ across the users, and how much total time and effort they spend on these processes. FIG. 1D illustrates an example user interface that shows how the process discovery technology attributes effort and statistics like the number of users who are conducting the process.

In some embodiments, a user may perform a process by performing a sequence of actions via a respective sequence of application UI screens, where each application UI screen may be generated by a respective one of the application programs executing on computing device 102. Process discovery module 101 may collect the action information and contextual information associated with visible and/or non-visible GUI elements across at least some or all application UI screens in the sequence of application UI screens. Process discovery module 101 may analyze the contextual information to identify attributes for each of the application UI screens. In some embodiments, identifying the attributes may include identifying, for each attribute, an attribute name, an attribute value, and/or a respective location in the particular application UI screen. For example, FIG. 2B illustrates a first attribute with a name “Customer Name,” and value “Acme Corp; a second attribute with a name “Module” and value “Data Agent,” a third attribute with a name “Reason” and value “Moved to State Closed”, and so on. In some embodiments, identifying the attributes may include identifying, for each attribute, only an attribute name, only an attribute value, only a location, any combination of two of attribute name, attribute value and location or all three. In some embodiments, a location of a GUI element may include coordinates indicating the location of the GUI element in the application UI screen.

As explained above, existing techniques (such as, API based techniques or DOM-based techniques) used for collecting data (e.g., action information, contextual information, attribute information, etc.) as the user interacts with a computing device have reliability, staleness and performance concerns. To address these drawbacks, the inventors have developed a metadata extraction system, such as metadata extraction system 430, that utilizes machine learning technology to extract metadata from application user interface (UI) screens while the user is interacting with them. This metadata can include action, contextual, and/or attribute information that is extracted using different machine learning models. The metadata extraction system can extract metadata using solely machine learning techniques or using machine learning techniques in combination with other data collection techniques. As such, the metadata extraction system can provide comprehensive metadata for purposes of generating a representation of the process or process discovery.

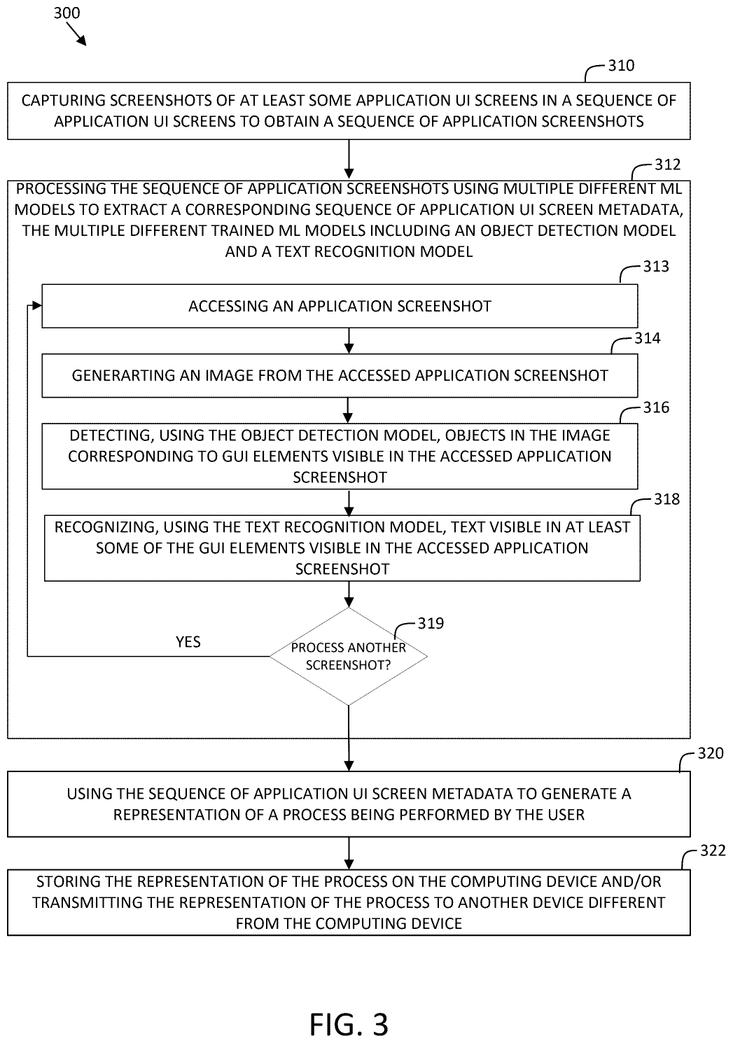

FIG. 3 illustrates a flowchart of a method 300 for gathering information about a process being performed by a user of a computing device, according to some embodiments of the technology described herein. At least some of the acts of method 300 may be performed by any suitable computing device(s) and, for example, may be performed at least in part by one or more computing devices 102 shown in process tracking system 100 of FIG. 1A. In some embodiments, computing device 102 may have application programs and separate monitoring software installed thereon. A user may perform the process by performing a sequence of actions via a respective sequence of application UI screens, each of the application UI screens being generated by a respective one of the application programs.

In act 310, screenshots of at least some application UI screens in the sequence of application UI screens may be captured to obtain a sequence of application screenshots. In some embodiments, the screenshots may be captured by making API calls to the OS. Other screen capture techniques may be used without departing from the scope of this disclosure.

The sequence of application screenshots may include a first application screenshot 500 shown in FIG. 5, for example. In some embodiments, the screenshots may be captured while the user is performing the process by performing the sequence of actions via the respective sequence application screens.

In act 312, the sequence of application screenshots may be processed using multiple different trained machine learning (ML) models to extract a corresponding sequence of application UI screen metadata. The sequence of application UI screen metadata may include first application UI screen metadata corresponding to the first application screenshot 500. In some embodiments, the multiple different ML models may include at least an object detection model and a text recognition model.

In some embodiments, processing the sequence of application screenshots using the multiple different ML models to extract a corresponding sequence of application UI screen metadata may include accessing an application screenshot in act 313; generating an image from the access application screenshot in act 314; detecting, using the object detection model, objects in the image corresponding to GUI elements visible in the accessed application screenshot in act 316; recognizing, using the text recognition model, text visible in at least some of the GUI elements visible in the accessed application screenshot in act 318; and determining whether another screenshot is to be processed in act 319.

In act 313, an application screenshot, such as the first application screenshot 500, may be accessed. An image may be generated from the accessed application screenshot in act 314. In some embodiments, generating an image from the first application screenshot 500 may include processing the image using one or more pre-processing techniques. The one or more pre-processing techniques include one or more of gray scaling, sharpening, and color inversion techniques. In some embodiments, processing the image using the one or more pre-processing techniques comprises determining a first type of the one or more pre-processing techniques to use to process the image based on a type of application program that generated an application UI screen for which the first application screenshot 500 was captured.

In act 316, an object detection model may be used to detect objects in the image corresponding to GUI elements visible in the first application screenshot 500. In some embodiments, the GUI elements visible in the first application screenshot may include one or more of the following: a screen title, an active tab, a tab, a horizontal key-value pair, a vertical key-value pair, an address bar, a drop-down menu, a text box, a table, a label, an overlay, a header, a footer, an icon, a check box, a radio button, and a button. As shown in FIG. 5, an object detection model may detect various objects 502, 504, 506, 508, 510, 512, 514, 516, 518, 520, 522 corresponding to screen title, tabs, text boxes, active tabs, labels, vertical key-value pairs, grid titles, drop-down menus, tables, buttons, and grids, respectively.

In some embodiments, the object detection model is a trained convolutional neural network that is trained to detect objects in screenshots. In some embodiments, the object detection model comprises millions of parameter values (e.g., 5-10 million, 5-20 million, 10-25 million, 10-50 million, 5-500 million, or any range of parameter values within these ranges). In some embodiments, the YOLO (You Only Look Once) family of object detection models is used to detect the objects in screenshots.

In act 318, a text recognition model may be used to recognize text visible in at least some of the GUI elements visible in the first application screenshot 500. In some embodiments, the text recognition model is an optical character recognition model for recognizing text strings in the at least some of the GUI elements. For example, the text recognition model may recognize the text “Vendors” visible in the active tab GUI element 508, the text “Account” visible in the label GUI element 510, the text “Approved” visible in the drop-down GUI element 516, and so on.

In act 319, a determination may be made regarding whether another screenshot in the sequence of screenshots is to be processed. In response to a determination that another screenshot is to be processed, the process loops back to act 313 where another screenshot is processed as described in acts 313, 314, 316, and 318. In response to a determination that another screenshot is not to be processed (e.g., all the screenshots in the sequence have been processed), the process proceeds to act 320.

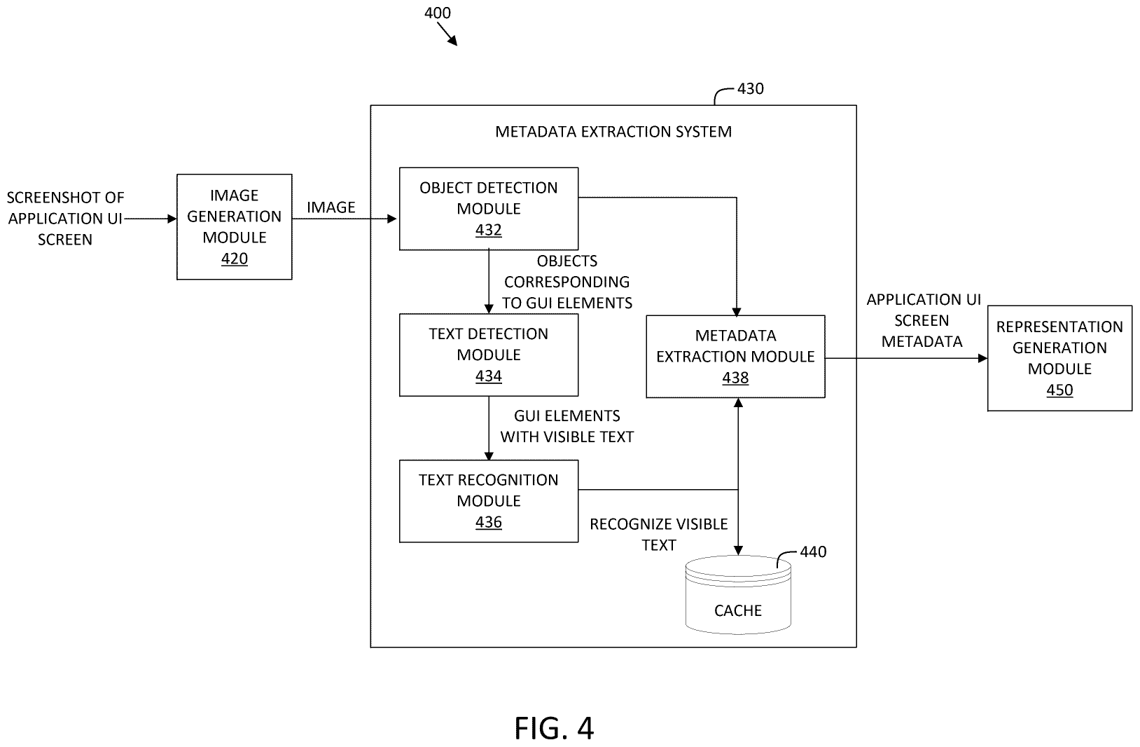

In some embodiments, the processing of the sequence of application screenshots described in acts 312, 313, 314, 316, 318 may be performed by metadata extraction system 430 shown in FIG. 4. As shown in FIG. 4, an image generation module 420 may generate an image from an accessed application screenshot, such as first application screenshot 500, as described in act 314. The image may be processed by metadata extraction system 430 to extract first application UI screen metadata from the first application screenshot 500. The first application UI screen metadata may include a hierarchy of one or more of the GUI elements visible in the first application screenshot, and for each of the one or more GUI elements, an element name, an element type, an element value, a location of the element in the screenshot (e.g., location of a bounding box of the element), a location of the element in an object hierarchy, and/or text visible in the element. In some embodiments, the location of a bounding box of an element may be specified in any suitable way, including for example by specifying coordinates of the bounding box such as pixel coordinates.

In some embodiments, the metadata extraction system 430 includes an object detection module 432, a text detection module 434, a text recognition module 436, a metadata extraction module 438, and a cache 440. The object detection module 432 is configured to perform act 316 where an object detection model is used to detect objects in the image corresponding to GUI elements visible in the first application screenshot 500. In some embodiments, the object detection module 432 may organize at least some of the objects detected using the object detection model into an object hierarchy and may include the object hierarchy as part of the first application UI screen metadata.

In some embodiments, text recognition module 436 is configured to perform act 318 where a text recognition model is used to recognize text visible in at least some of the GUI elements visible in the first application screenshot 500. The inventors have recognized that using text detection techniques to first identify which GUI elements contain text prior to passing them to the text recognition module 438 for text recognition provides resource and performance optimization benefits. In some embodiments, a text detection module 434 is configured to identify, using a text detection technique, the at least some of the GUI elements (with visible text) from among the GUI elements visible in the first application screenshot for which objects were detected using the object detection model. The text recognition model recognizes text visible in those identified at least some of the GUI elements instead of all the GUI elements.

In some embodiments, metadata extraction module 438 may generate the first application UI screen metadata corresponding to the first application screenshot based on information obtained from the object detection module 432 and the text recognition module 436. For example, the object detection module 432 may provide the object hierarchy of detected object(s) corresponding to GUI element(s) visible in the first application screenshot to the metadata extraction module 438 along with the information regarding each of the GUI element(s) (e.g., element name, element type, element value, location of bounding box of element, etc.). The text recognition module 436 may provide, for each of the GUI elements that contain visible text, the recognized text, and the location of the bounding box of the recognized text to the metadata extraction module 438.

In some embodiments, the metadata extraction module 438 may generate a sequence of application UI screen metadata corresponding to a sequence of application UI screenshots based on processing of the sequence of the application UI screenshots performed by the object detection module 432, the text detection module 434, and/or text recognition module 436. The metadata extraction module 438 may combine the information obtained from the object detection module 432, the text detection module 434, and/or text recognition module 436 to generate comprehensive metadata for each of the screenshots. For example, the metadata extraction module 432 may, for each screenshot, combine information obtained regarding the objects detected in the screenshot with information regarding visible text recognized in the corresponding GUI elements. The information may be combined based on the location of the bounding boxes of the GUI elements obtained from the object detection module and the location of bounding boxes of recognized text obtained from the text recognition module 436. For example, the object detection module 432 may detect an object 508 corresponding to an active tab GUI element and output the location of the bounding box of the active tab GUI element. The text recognition module 436 may recognize text (“Vendors”) visible in the active tab GUI element and output the location of the bounding box of the recognized text. The metadata extraction module 438 may determine whether the locations from the object detection module 432 and the text recognition module 436 overlap. In response to a determination that the locations overlap, the metadata extraction module 438 may determine that “Vendors” corresponds to text that is visible in the active tab GUI element and may associate the recognized text with the active GUI element in the metadata and/or object hierarchy.

In some embodiments, the metadata extraction system 430 includes a cache 440 which may be part of the volatile memory of the computing device 102. The inventors have recognized that many GUI elements do not change across multiple application screenshots such that the location of the bounding boxes for those GUI elements along with the text visible in them remain the same across the multiple application screenshots. The inventors have developed a caching technique that provides substantial performance improvements by reducing the number of times the text recognition model needs to be run to recognize text across these multiple application screenshots.

For example, the sequence of application screenshots may include a first and a second application screenshot generated by an application program. These screenshots may be processed by caching, in volatile memory of the computing device 102, text strings recognized using the text recognition model in association with information about the corresponding GUI elements (e.g., locations of bounding boxes of the corresponding GUI elements) visible in the first application screenshot, and accessing at least some of the text strings cached in the volatile memory of the computing device 102 instead of using the text recognition model to recognize text in at least some GUI elements visible in the second application screenshot that correspond to the GUI elements visible in the first application screenshot. In some embodiments, caching the text strings is performed by caching the text strings using hashes of pixels in the bounding boxes as keys to a cache 440. In some embodiments, the cached text strings may be flushed from the cache 440 when the application program closes or restarts or according to a schedule.

Referring back to FIG. 3, in act 320, the sequence of application UI screen metadata may be used to generate a representation of the process being performed by the user. The sequence of application UI screen metadata may be used, by representation generation module 450 of FIG. 4, to generate a representation of the process. In act 322, the representation of the process may be stored on the computing device and/or transmitted to another device different from the computing device. Some aspects of generating representations of processes are described in PCT Application PCT/IN2024/050370, titled “MACHINE LEARNING SYSTEMS AND METHODS FOR AUTOMATED PROCESS DISCOVERY,” filed on Apr. 10, 2024, which is incorporated by reference herein in its entirety. In some embodiments, personally-identifiable information (PII) may be removed or masked in the sequence of application UI screen metadata prior to performing acts 320 and/or 322.

In some embodiments, acts 310, 312, 313, 314, 316, 318, and/or 319 are performed locally on computing devices 102 in accordance with limits specified by a resource utilization policy described in section titled “Constraints” herein. A configuration specifying the resource utilization policy applicable to a computing device may be accessed. The resource utilization policy specifies limits on utilization of one or more computing device resources during performance of acts 310, 312, 313, 314, 316, 318, and 319 by software executing on the computing device. This allows for local metadata extraction to be performed without transmitting images to be processed on the server or writing them to disk which has significant privacy and resource optimization benefits.

Described herein is a metadata extraction system that can run on computing systems such as desktops, mobile phones, tablets, or other computing devices capable of running the different ML models. The visual approach of data collection described herein works across diverse applications such as Windows Applications, Java applications, SAP, Mainframe, Web applications, and others. The approach is easily extensible given that all one needs to do is annotate more sample images for the training of the models. The object detection model described herein is an example of a particular architecture that can be trained for object detection, but this approach is extensible to other architectures that meet the constraints described herein.

### Object Detection

As explained above, an object detection model may be used to detect objects in an application screenshot corresponding to GUI elements visible in the application screenshot. In some embodiments, OS-specific and/or image processing APIs may be used to:
(1) identify a foreground application;
(2) match the identified foreground application to an application detected as the destination for a user action (e.g., a mouse click or keystroke);
(3) If there is a match,
   (a) use an OS API to take a screenshot of the foreground application window,
   (b) convert the image to a normalized color space that an object detection model is trained to process,
   (c) pre-process the image using pre-processing techniques that optimize detection based on application type (such as, Windows, Java, Web app, SAP, MacOS, etc.). These pre-processing techniques can include gray scaling, sharpening, inverting colors, and/or other image processing techniques. These techniques may be experimentally discovered during training and/or preconfigured as techniques which optimize accuracy for a particular UI technology or specific application, and
   (d) then pass the image on to an object detection model. Object detection models may be specialized based on UI technology or application depending on how unique the application is or how sensitive it is. End users may train their own model for a private application that is not widely used as aspects of the technology described herein are not limited in this respect.

In some embodiments, a trained convolutional neural network that is trained to detect objects in screenshots may be used as an object detection model. In some implementations, the YOLO family of object detection models may be used for object detection. The YOLO family of object detection models may be trained on application screenshots and may be used to detect objects corresponding to GUI elements visible in the application screenshots and the object hierarchy at runtime, for example, while a user interacts with applications carrying out various business activities.

YOLO (You Only Look Once) is an object detection model that operates by dividing an input image into a grid and predicting bounding boxes and class probabilities for objects within each grid cell simultaneously. It uses a single convolutional neural network to directly predict these bounding boxes and class probabilities, making it fast and efficient for real-time object detection tasks such as GUI element detection. The approach described herein of capturing screenshots of application UI screens, generating images from the screenshots, processing the images using an object detection model allows for:
capturing the full UI hierarchy as visible to the user including key value pairs, such as label and textbox,
capturing the visible rectilinear grid that the user is viewing or interacting with including all key-value pair information on the UI screen (e.g., horizontal and vertical key-value pairs),
using a predictable amount of memory (up to a maximum of full screen size),
avoiding API-based race conditions,
not triggering third-party bugs in APIs which cause user-visible application slowdowns or crashes,
execution on a user computing device without necessarily requiring acceleration hardware,
execution entirely on a user computing device and maintaining privacy by allowing filtering (e.g., removing or masking PII) of results before sending to a server,
processing screenshots entirely in memory without touching a disk,
working only on foreground application that users interact with respecting privacy,
capturing interactions with modern artificial intelligence (AI) software such as copilots,
working across various different UI technology such as, but not limited to, Web applications, Windows, Java, MacOS, SAP, Linux, Android, IOS, Mainframes, and other technologies, and
providing all visible information for inferring data previously gathered by API technology, such as application name, screen title, element type, element name, and element value.

An application UI screen consists of a hierarchy of GUI elements from the entire application UI screen to buttons and text boxes, and down to individual characters of text. Similar to API-based UI hierarchies, application UI screens have a visual hierarchy that can be used to navigate the screens and visually interact with applications on computing systems. An example visual hierarchy of an application UI screen is represented in the screenshot 500 of FIG. 5. As shown in FIG. 5, an object detection model is used to detect various objects 502, 504, 506, 508, 510, 512, 514, 516, 518, 520, 522 in an image corresponding to GUI elements visible in the screenshot 500.

As shown in FIG. 5, a screentitle 502 is identified such as “NETSUITE”, tabs 504 are identified such as “Activities”, “Customers”, an active tab 508 is identified such as “Vendors”, labels 510 are identified such as “ACCOUNT”, and hierarchical elements such as vertical key-value pairs 512 are identified such as “VENDOR*” and “Apple Inc”.

In some implementations, the object detection model is based on the PP-YOLOE architecture, which is an open-source model that can make predictions for objects corresponding to GUI elements visible on the UI screen in one go. A small model having about 7.5 million parameters that can be estimated and/or tuned during training may be used. The model detects different classes of objects on screen, such as, but not limited to, active tabs, tabs, horizontal key-value pairs, vertical key-value pairs, addressbars, dropdowns, textboxes, tables, labels, overlays, headers, icons, and buttons. For example, the model can detect at least 13 different classes. The model output may include, for each detected object, a class ID, a confidence score, and a location of a bounding box of the corresponding GUI element. The location of the bounding box may include pixel coordinates.

It will be appreciated that any object detection model with similar performance as the PP-YOLOE may be used without departing from the scope of this disclosure. In some implementations, any sufficiently fast object detection model that works within the constraints listed below in section titled “Constraints” may be used. For example, other object detection models from the YOLO family may be used. Examples of object detection models from the YOLO family may include but not be limited to, the YOLOv4 model described in article titled “YOLOv4: Optimal Speed and Accuracy of Object Detection,” by Bochkovskiy et al. (2020, arXiv: 2004.10934), and the PP-YOLOE model described in article titled “PP-YOLOE: An evolved version of YOLO,” by Xu et. al. (2022, arXiv: 2203.16250), each of which is incorporated by reference herein in its entirety.

Other object detection models such as Detection Transformer (DETR) described in article titled “End-to-end object detection with transformers,” by Carion et al. (European Conference on Computer Vision-ECCV 2020, pp. 213-229, arXiv: 2005.12872) and SSD described in article titled “SSD-Single Shot MultiBox Detector,” by Liu et al. (European Conference on Computer Vision-ECCV 2016, pp. 21-37, arXiv: 1512.02325) may be used, each of which is incorporated by reference herein in its entirety. In some embodiments, the techniques described herein for annotation and training in section titled “Training” are extensible to these other object detection models.

Although training and using one extensible, general base model, is described herein, it will be appreciated that the system framework supports running specialized models based on UI type (Windows, Linux, Java UI, Web UI, etc.), or application type (Office, SAP, homegrown application, etc.) switching between them at inference or detection time.

In some embodiments, to perform object detection, an image of the desktop or the application UI screen (application window) that is active is obtained. For privacy reasons, the image representation may only be stored in memory and need not be written to or saved to disk. The image may be passed to the object detection model for inference where the model detects all objects corresponding to GUI elements visible in the image as shown in FIG. 5 that has a visual hierarchy in it. With each object that is detected, a confidence score is provided. That confidence score can be used to only choose certain objects and filter out low confidence ones. As shown in FIG. 5, the objects are detected hierarchically wherein an input box can be inside a horizontal key-value pair. A label can also be inside of an input box, and so on.

When detection is complete, objects can be reported by the object detection model in a structured format, such as an example format shown below:

```
[
  {
    “name”: “vkv”,
    “class”: 31,
    “confidence”: 0.895989179611206,
    “box”: {
      “x1”: 1113.568603515625,
      “y1”: 340.30780029296875,
      “x2”: 1413.396728515625,
      “y2”: 388.0688781738281
    },
    “track_id”: 1
  },
  {
    “name”: “acttab”,
    “class”: 2,
    “confidence”: 0.8878070116043091,
    “box”: {
      “x1”: 371.2701416015625,
      “y1”: 128.90725708007812,
      “x2”: 442.4815979003906,
      “y2”: 157.88253784179688
    },
    “track_id”: 2
  },
  {
    “name”: “vkv”,
    “class”: 31,
    “confidence”: 0.8812926411628723,
    “box”: {
      “x1”: 23.665313720703125,
      “y1”: 732.6934814453125,
      “x2”: 333.24554443359375,
      “y2”: 782.1781616210938
    },
    “track_id”: 3
  },
  {
    “name”: “vkv”,
    “class”: 31,
    “confidence”: 0.8728154897689819,
    “box”: {
      “x1”: 1112.37548828125,
      “y1”: 283.5877685546875,
      “x2”: 1418.0909423828125,
      “y2”: 337.9681701660156
    },
    “track_id”: 4
  },
  {
    “name”: “vkv”,
    “class”: 31,
    “confidence”: 0.8477216362953186,
    “box”: {
      “x1”: 561.8721923828125,
      “y1”: 673.6797485351562,
      “x2”: 867.6184692382812,
      “y2”: 724.5625610351562
    },
    “track_id”: 5
  },
  {
    “name”: “button”,
    “class”: 4,
    “confidence”: 0.8343320488929749,
    “box”: {
      “x1”: 425.693603515625,
      “y1”: 212.11846923828125,
      “x2”: 512.2053833007812,
      “y2”: 244.55552673339844
    },
    “track_id”: 6
  },
  {
    “name”: “tab”,
    “class”: 22,
    “confidence”: 0.8314573168754578,
    “box”: {
      “x1”: 386.485595703125,
      “y1”: 854.08935546875,
      “x2”: 486.177001953125,
      “y2”: 880.5978393554688
    },
    “track_id”: 7
  }...
]
```

As shown in the example output above, each object is listed with its bounding box, class, and confidence score. This output can then be parsed to create the Interaction data and the Attributes on the screen. Object detection models like the one used also provide tracking capabilities which allow for tracking the objects as the user scrolls the screen or even moves other screens over it obstructing part of the objects. The purpose of the tracking is that it simplifies the creation of object hierarchy. The hierarchical objects therefore only need to be recreated if they are new to the tracking subsystem or obstruction has broken the tracking substantially.

To finalize objects and their bounding boxes, the bounding box can then be passed to a text recognition model, still in memory without necessarily being written to disk, to be able to also extract and associate the text with the object. For example, if the detected object was of type ‘tab’, it is a tab control in an application. The pixel values in the bounding box can then be passed to the text recognition model for it to extract the visible in the bounding box. That text can then be added to the object's structured representation shown above and for the hierarchical object detection.

In some embodiments, object detection may be performed using a combination of different technologies, for example, machine learning and API technologies. The type of technology used may depend on an application type. A configuration file may be maintained specifying for each application, the type of object detection technique (for example, API call, a particular object detection model and its version, etc.) to be used. To use the configuration file, the name of the application may be detected and then based on detected application name the object detection technique specified in configuration file may be used. In some cases where it may be hard to detect the application name, a classifier may be developed that takes the screenshot as input and outputs the application name. The output can then used to identify the object detection technique to be used from the configuration file.

### Training the Object Detection Model

In some embodiments, training data including a plurality of annotated screenshots of at least some of the application UI screens may be obtained and the obtained training data may be used to train the object detection model.

Training of the object detection model is performed using annotated images of application UI screens, where all of the objects are annotated with bounding boxes and their object class. Annotated images may be generated using any suitable technique. For example, images of application UI screens may be hand-annotated with all of the classes and be provided as training data for the model. As another example, synthesized images of application UI screens may be generated and metadata associated with the objects such as their bounding boxes plus classes may be saved with the images while they are being synthesized. As yet another example, machine rendered images may be generated annotated with machine generated labels. For example, through web automation which scrapes various web pages rendering images of them and then using the DOM objects to create labelled objects with classes.

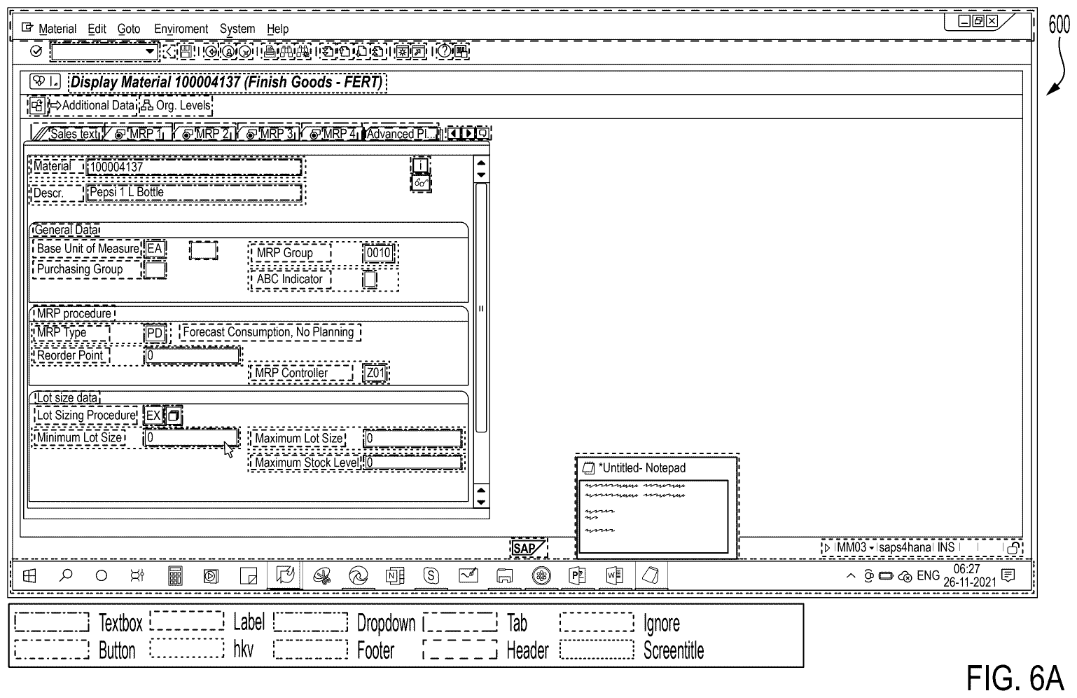

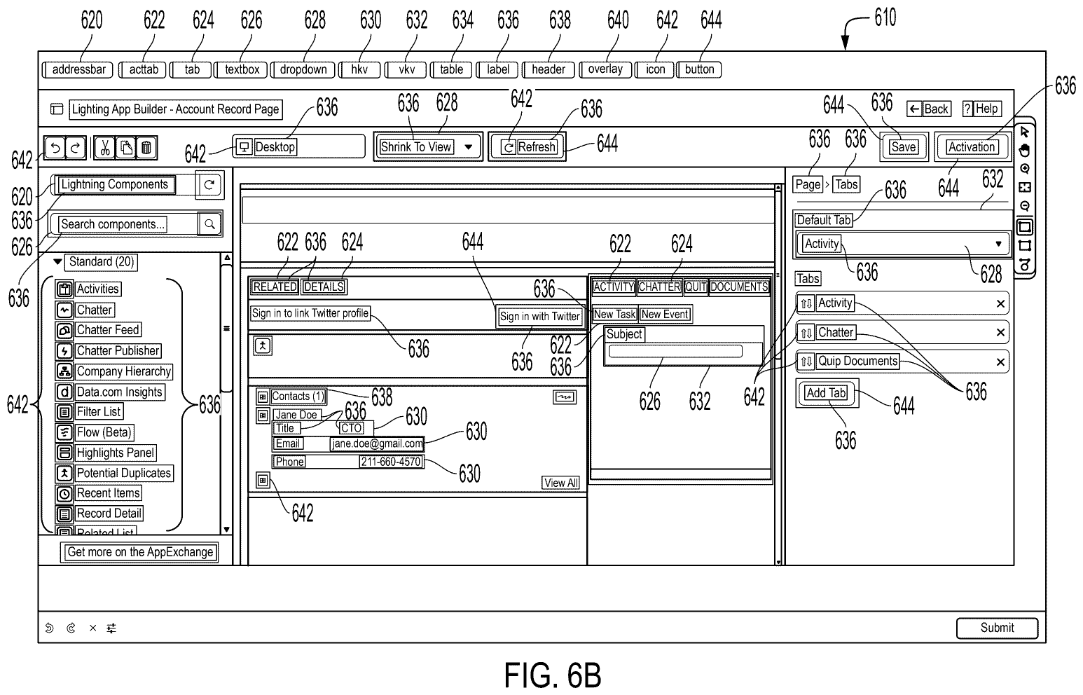

Example annotated screenshots 600, 610 used for training an object detection model are shown in FIGS. 6A and 6B, where bounding boxes are drawn around the objects and the appropriate labels are associated with them. As shown in FIG. 6A, various objects such as textbox, button, label, horizontal key value pair, drop down, footer, header, tab, and screen title may be labeled. In some embodiments, certain items in the screenshot, for example, a view of an application that is not active, may be labeled as “ignore” to indicate that such items are to be ignored during object detection. FIG. 6B is another example of an annotated screenshot, where objects such as objects 620, 622, 624, 626, 628, 630, 632, 634, 636, 638, 640, 642, and 644 may be labeled.

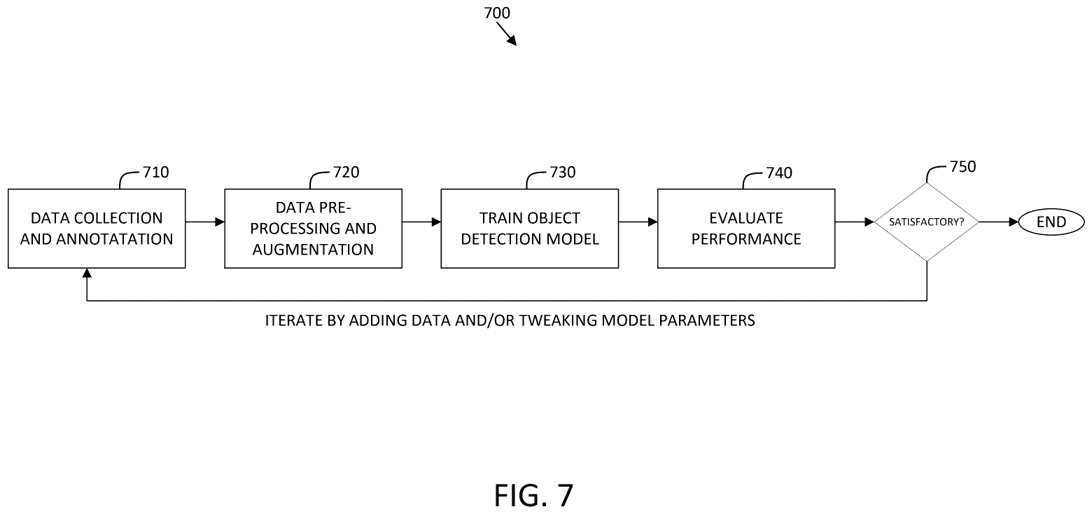

FIG. 7 is a block diagram of an example pipeline 700 used to train an object detection model, according to some embodiments of the technology described herein. Screenshots may be captured and annotated in block 710. In block 720, various data pre-processing (e.g., cleaning and transforming) and augmentation (e.g., image modifications to create variations) techniques may be used to prepare the data for the object detection model. In block 730, the object detection model may be trained using the training data obtained from block 720. The performance of the object detection model may be evaluated in block 740. A determination of whether the performance of the model is satisfactory may be made in block 750. If the performance of the model is satisfactory, it can be used for object detection. For example, if the performance metrics of the model, such as accuracy, precision, recall, and/or other performance metrics meet or exceed a pre-defined threshold, the performance of the model may be considered satisfactory. On the other hand, if the performance of the model is unsatisfactory, the model can be tuned by adding more data or modifying model parameters until the performance is deemed satisfactory.

A non-exhaustive list of object classes that can be used for annotation and training for reliable object detection is shown below.

| S# | Class name | Description | Remarks |
|---|---|---|---|
| 1 | actcheck | Active check box | A selected check box |
| 2 | actradio | Active radio button | A radio button that is selected |
| 3 | acttab | Active tab | A tab that is currently open/active |
| 4 | addressbar | URL on the browser | The addressbar or the url |
| 5 | button | Button | Clickable buttons |
| 6 | check | Check box | An unselected check box |
| 7 | datetimepicker | Date-time picker | A box that has the option to pick dates from a calendar |
| 8 | dropdown | Drop down | A box to pick a list of pre-decided values |
| 9 | footer | Screen footer | The footer on the screen |
| 10 | Grid | Grid | A group of elements within a visually well-defined |
| | | | boundary |
| 11 | gridtitle | Grid title | The name/title of the grid (defn. above) |
| 12 | header | Screen header | The header on the screen |
| 13 | Hkv | Horizontal key value pair | A combination of a key + value aligned horizontally |
| 14 | label | Label | Any name of a field/screen |
| 15 | listbox | List box | A text box with a list of options |
| 16 | taskbar | Operating system task bar | The operating system task bar containing the OS′ icons, |
| | | | time, date etc. |
| 17 | pwdtext | Password text | The encrypted text box for passwords |
| 18 | radio | Radio button | A radio button that is not selected |
| 19 | screentitle | Screen title | Name on the screen that is visible |
| 20 | selrow | Selected row | A row that is selected in a table |
| 21 | tab | Tab | A tab that is available, but not open/active on the screen |
| 22 | tabcontrol | Tab control | A bunch of tabs displayed at the top of the window |
| 23 | tabheader | Tab header | Header of a tab |
| 24 | table | Table | A table of values with header |
| 25 | tablehdr | Table header | The column names of a table |
| 26 | textbox | Text box | A text box that can take values/displays text |
| 27 | treeview | Tree view | A hierarchical view of values |
| 28 | unselrow | Unselected row | The remaining unselected rows from “listbox” |
| 29 | vkv | Vertical key value pair | A combination of a key + value aligned vertically |
| 30 | window | Window | A window within a screen (pop-up) |
| 31 | wintitle | Window title | The name of the window/pop-up |
| 32 | menu | Menu | Menus are controls that contain a simple list of options |
| | | | from which users may only select one option at a time |
| 33 | menuitem | Menu item | The selected option from the menu is a menu item |
| 34 | ignore | Ignore | A class to annotate fields that can be ignored by the Al |
| | | | algorithm |

Every annotated image has bounding boxes drawn around the respective part of the image with a label of the appropriate class. Nested objects are annotated to ensure reliable detection of hierarchical objects. For example, if there is a table in the image then the entire table may have a bounding box around it, and then the header of the table may have a bounding box inside of the outer table bounding box annotated. Then, each row in the table may also be annotated.

One example framework for training an object detection model is described where pre-trained weights for the PP-YOLOE object detection model as provided by the PaddlePaddle framework are used as a starting point. These pre-trained weights were obtained by training the same model on the COCO (Common Objects in Context) dataset as described in article titled “Microsoft COCO: Common Objects in Context,” by Lin et al. (European Conference on Computer Vision-ECCV 2014, pp. 740-755, arXiv: 1405.0312), which is incorporated by reference in its entirety herein. The model is then further trained on a custom dataset consisting of about 3500 images of enterprise applications. These images were obtained by taking screenshots while conducting various processes in these applications. The screenshots are manually annotated using an annotation tool, such as LabelStudio described in “Label Studio,” (https://labelstud.io/, last commit Apr. 29, 2025), which is incorporated by reference in its entirety herein, and which defines the “ground truth” against which the model can be trained and tested. Once the model is trained on these images, it can be used to predict the object classes of interest.

### Hierarchical Object Detection and Reconstruction

There are various classes as described in the “Training of Object Detection Model” section that are hierarchical in nature, which lead to the hierarchical object detection and reconstruction of interacted fields and non-interacted fields such as Attributes. All objects are provided with their bounding boxes as described above. Nested bounding boxes naturally describe hierarchy in the objects that were detected. For example, an object with a ‘table’ class has a bounding box that typically encapsulates a bounding box of the table's header row which is of a class ‘tablehdr’. And within the ‘table’ class bounding box object, there are rows in the table. This is an example of how a hierarchical set of objects may be reconstructed from the output provided by the model.

For some “Attributes”, there are Horizontal Key Values (hkv class) and Vertical Key Values (vkv class). Horizontal key values are bounding boxes that contain a label and an input such as an input/text box and can therefore be associated with each other in the more structured hierarchical way represented by interacted fields and non-interacted fields in “Attributes”. The same is true with vertical key values, which contain a label and an input that are vertically aligned (e.g., when a label is above an input box). This post-processing is done to associate the objects that were detected further into their structured hierarchy, where nested bounding boxes have a hierarchical relationship to their outer parent bounding box. Using this technique, the “Attributes” may be reconstructed on the screen. Using the recognized text output from the text recognition model that was associated with the classes, the text from the label (i.e., the Attribute name) and the text for the value (i.e., the Attribute value) may be obtained.

This hierarchical representation can be provided as a nested list of objects in a more structured format such as JSON, XML, or a more object-oriented class style. That can create a tree-like representation of the objects, which is a common representation of objects in applications as described in U.S. Pat. No. 10,990,238 by Nychis et al., titled “Software Robots for Programmatically Controlling Computer Programs to Perform Tasks,” which is incorporated by reference herein in its entirety.

It will be appreciated that this hierarchical object detection and reconstruction can be performed independent of the type of application technology used. In particular, the hierarchical object detection and reconstruction can be performed on any application image on which an inference is performed using the technology described herein.

### Text Detection and Recognition

A text detection model looks for individual words in images and a text recognition model translates the individual word images to actual text.

Any suitable model may be used for text detection and text recognition. Examples of some implementations are described below:
(1) Use the same PP-YOLOE small model architecture as used for the object detection model for text detection, though this one only detects individual words in images. For the text recognition model, the recognizer of the PaddleOCR model may be used, as described in article titled “PP-OCR: A Practical Ultra Lightweight OCR System,” by Du et al. (arXiv: 2009.09941), which is incorporated by reference herein in its entirety.
(2) Use both the text detection and text recognition functionality of the PaddleOCR model.
(3) Use Microsoft's OCR model described in “OCR-Optical Character Recognition,” (https://learn.microsoft.com/en-us/azure/ai-services/computer-vision/overview-ocr, Oct. 17, 2024), which is incorporated by reference herein in its entirety.

The implementation used depends on the customer environment and the available resources. Output in all cases has the same format: a list of text objects with confidence score, bounding box coordinates, and the actual text.

For training the models, images of enterprise applications are not necessarily needed, just that the images have text. A base image set of 70000 images that contain text in them is processed using Amazon Textract, described in “Amazon Textract,” (https://aws.amazon.com/textract/, 2025), which is incorporated by reference herein in its entirety, to obtain “ground truths”. The ground truths are bounding boxes around individual words. The models noted in implementations (1) and (2) above are trained on this dataset. The Microsoft OCR model may be used out of the box without training.

### Combining Objects and Text

The object and text models use the same image to make their respective predictions. The detected objects are then put within a nested hierarchy: some objects can be a child element of a parent object. For example, textboxes usually have a label inside them, so the label is a child element of the textbox in the hierarchy. Similarly, label objects obtained through object detection are populated with text objects obtained through text recognition. This is done by computing the overlap between objects, such as the intersection-over-union metric. If the overlap exceeds a certain threshold (which may be set at ˜0.5 or another threshold, for example), then one object is assigned as a child element of the other object using a priority rule (e.g., text is child element of label, textboxes and dropdowns are child elements of horizontal/vertical key-value pairs, etc.).

### Optimizations

As described above, the inventors have developed various optimization techniques that enable metadata extraction to be performed on the user's computing device while addressing privacy concerns. For example, a first optimization recognized when coupling object detection with text recognition is the reuse of cached recognized text across multiple application screens. For example, the text recognition model may provide OCR output representing the recognized text. The pixel values in the bounding boxes with the OCR output may be cached in memory. In that way, if the same bounding box is requested to be OCR′ed when the object detection model runs again, the entire OCR engine (which is CPU and memory consuming) does not need to be run. Instead, the cached text may be fetched from the cache where a hash of the pixel values in the bounding box are the key to the cache, and the resulting OCR value is the value in the cache. This provides substantial performance improvements, since many things on the application screen do not change as users use the applications. The cache can be periodically flushed when the application closes or restarts or according to a schedule.

A second optimization is to use text detection techniques (e.g., using a text detection machine learning model as described herein) to determine which bounding boxes potentially have text in them before passing them to the OCR engine. That is because detecting whether a GUI element contains text but not recognizing this text requires less computation than recognizing the text contained in the GUI element. As such, this optimization reduces the load of the OCR engine on the computing device, while working within the bounds of computing system resources.

A third optimization is to enable screen capture and metadata extraction to operate on an end user computing device in accordance with limits on utilization of computing device resource(s) specified by a resource utilization policy specifying one or more constraints as described in detail in section titled “Constraints” below.

### Constraints

As mentioned above, to operate on an end user computing device, screen capture and metadata extraction follow one or more of the following constraints to ensure reduced disruption (e.g., slowness or crashes) of end users' business work:
Use no more than 5%-6% of system memory (RAM; 400-500 MB on an 8 GB system),
Use no more than 10% of CPU cycles,
Use no more than 1 GB of disk space (for model storage),
Work on up to 10-year-old CPUs without AVX-512 or deep learning network acceleration hardware, and
Execute within 2 seconds to handle end user interaction load of ˜10,000 events per day.

It will be appreciated that an appropriate set of constraints may be used without departing from the scope of this disclosure.

Resource constraints may be enforced on the entire approach from application identification, to preprocessing, to object detection, by layering process container technology on top of it. Hardware limitations are inherent to the runtime environments such as a 10-year-old Intel Xeon or AMD EPYC™ platforms used typically for virtual desktop environments by end users in corporate settings.

On Windows, that means using JobObject technology to limit CPU, limit RAM, and timing out the execution.

On Linux, that means using cgroups technology to limit CPU, limit RAM, and timing out the execution.

Other operating systems can use their respective container or container-like technology to limit CPU, RAM, and enforce timeout constraints.

The above constraints rule out many object detection approaches that require acceleration, or more resources than allowable on end user systems.

### Use Cases

As described herein, the object detection module provides a hierarchical set of objects that are visible on the application UI screen which provides reliable and complete digital interaction data. This provides a large amount of high-quality “Attributes” as was previously described. The metadata extracted as described herein can be used by process discovery and analysis techniques that were described in U.S. Pat. No. 11,816,112, titled “SYSTEMS AND METHODS FOR AUTOMATED PROCESS DISCOVERY,” granted on Nov. 14, 2023, filed on Apr. 2, 2021; U.S. Pat. No. 12,020,046, titled “SYSTEMS AND METHODS FOR AUTOMATED PROCESS DISCOVERY,” granted on Jun. 25, 2024, filed on Apr. 1, 2022; and in PCT publication No. WO2024/074891, titled “SYSTEMS AND METHODS FOR IDENTIFYING ATTRIBUTES FOR PROCESS DISCOVERY filed Sep. 29, 2023, each of which is incorporated by reference herein in its entirety.

In some embodiments, the metadata extracted as described herein may be used to create representations (e.g., numerical representations) of known processes and then mining for those representations from data collected by monitoring one or more users. A process discovery software system can generate numerical representation(s) of a particular process. This is done through a teaching mechanism in which the process discovery software is placed into a “teaching mode” and one or more users perform one or more instances of the particular process while the process discovery software is capturing click and/or keystroke data as the user interacts with his/her computing device using multiple different application programs, user interfaces of the application program(s), and the buttons, fields, and other user interface elements therein. In turn, the taught process instances may be used to generate the numeric representation(s) of the process. The generated numeric representation(s) may be then used to discover, efficiently, other instances of the process from data collected by monitoring one or more other users (e.g., other users at an enterprise).

One or more users “teach” the process by performing a plurality of actions that collectively form the process while interactions between the user and their computing device are captured (e.g., by using a process discovery module 101 executing on the computing device). Each performance of the process by a user may be called an “instance” of the process, and the data captured during the user's performance of the instance may be stored in association with the instance (e.g., in association with an identifier corresponding to the instance of the process). Specifically, with respect to teaching, an instance performed during teaching may be called a “teaching instance” performed by a user, and a collection of instances taught by one or more users for a particular process may be called the “taught instances” for that process. The information captured during a user's performance of a teaching instance may be called a “stream of events,” a “plurality of events” or simply “events.” The events in a stream of events may correspond to individual keystrokes, clicks, etc. captured by the process discovery module during performance of the teaching instance.

As described above, a process refers to a plurality of user actions that are collectively performed to achieve a task. The task may be any suitable task that could be performed by a user (or multiple users) by interacting with one or more computing devices. The task, in some embodiments, may be any suitable task that one or more users perform in a business such as, for example, one or more accounting, finance, IT, human resources, purchasing and/or any other types of tasks. For example, a process may refer to a plurality of user actions that a user takes to perform the task of receiving a purchase order, reviewing the purchase order, and approving the purchase order. As another example, a process may refer to a plurality of user actions that a user takes to perform the task of opening an IT ticket for an issue (e.g., resetting a user's password), addressing the issue, and closing same (e.g., by resetting the password and notifying the user whose password was reset that this is completed). Some processes may include only a few (e.g., 2 or 3) user actions, whereas other processes may include more (e.g., tens, hundreds, or thousands) user actions. As described herein, a process is a unit of discovery that is searched for during “process discovery” to identify instances of the process in data other than training data, often referred to herein as “wild data” or “data in the wild.” In some embodiments, the “wild data” may be data captured during interaction between users and their computing devices. The data captured may include keystrokes, mouse clicks, and associated metadata described herein including with reference to FIGS. 2A-B, 3-5, 6A-6B, and 7.

One or more numeric representations of the process may be generated based on the taught instances of the process. In some embodiments, the one or more numeric representations of the process may be generated using at least one trained machine learning model as described in PCT Application PCT/IN2024/050370, titled “MACHINE LEARNING SYSTEMS AND METHODS FOR AUTOMATED PROCESS DISCOVERY,” filed on Apr. 10, 2024, which is incorporated by reference herein in its entirety.

In some embodiments, the one or more numeric representations of the process may include a single numeric representation of the process corresponding to the stream of events. The single numeric representation of the process may be generated by processing at least some of the metadata associated with the stream of events (e.g., metadata including attribute values that do not include natural language text and/or complex values such as textual phrases, sentences, paragraphs, etc.) using the first trained ML model and at least some other of the metadata associated with the stream of events (e.g., metadata including attribute values that include natural language text and/or complex values such as textual phrases, sentences, paragraphs, etc.) using the second trained ML model.

The generated numeric representation(s) is used to discover the process (referred to herein as “process discovery” or simply “discovery”) in wild data (i.e., data on which the process was not taught). Each identification of the process during process discovery may be called a “discovered instance” or “observed instance” of the process. Similar to data captured during performance of a teaching instance, the wild data may also correspond to a stream of events performed by a user, and process discovery may operate by discovering the process in the stream of events.

In some embodiments, a user may perform a process by performing a sequence of actions via a respective sequence of application UI screens, and a visualization of at least some of the sequence of actions may be generated using the representation of the process. Examples of such visualizations are shown in FIGS. 11F, 11G, 11H, 11I of U.S. Pat. No. 12,020,046, titled “SYSTEMS AND METHODS FOR AUTOMATED PROCESS DISCOVERY,” granted on Jun. 25, 2024, filed on Apr. 1, 2022, which is incorporated herein by reference in its entirety.

Some additional use cases of the metadata described herein in the context of process discovery are as follows:
Finding repetitive patterns in the digital interaction data.
Calculating automatability of processes by using the digital interaction data.
Using the Attributes to associate discovered process sequences to particular metadata found in the process.
Estimating benefits of changes to processes which ultimately change the digital interactions, e.g., by automating some of them or making them more efficient.

In some embodiments, the metadata extracted using the techniques described herein may be used to describe or summarize user interactions as described in PCT application PCT/IB2025/000026, titled “MACHINE LEARNING TECHNIQUES FOR IMPROVING CONTEXT AND UNDERSTANDING OF USER INTERACTION-BASED DATA,” filed Jan. 10, 2025, and U.S. application Ser. No. 19/016,076, titled “MACHINE LEARNING TECHNIQUES FOR IMPROVING CONTEXT AND UNDERSTANDING OF USER INTERACTION-BASED DATA,” filed Jan. 10, 2025, each of which is incorporated by reference herein in its entirety.

The inventors have recognized that although the click and keystroke captured while performing a process can provide some level of detail about the process, reviewing the low-level data to understand the high-level steps performed to complete the process is a cumbersome task. For instance, manually reviewing a series of interactions (e.g., 200, 300, 400, 500, 600, 700, 800, 900, 1000 or more interactions) between a user and one or more applications programs to understand how a process is performed is impractical and extremely difficult. This is because in addition to the sheer volume of the click and keystroke data captured across multiple applications, this low-level interaction data is not captured in an easily-comprehensible user-friendly format. Moreover, manual review of these data would need to be performed by an experienced user possessing technical knowledge about the low-level machine code and hardware and the sheer volume of such data makes manual review impossible.

To address these drawbacks, the inventors have developed techniques for efficiently providing accurate textual summaries of user interaction data. The textual summaries can be presented (e.g., displayed) in a comprehensible user-friendly format. Machine learning is used to enable provision of textual summaries in part by processing the interaction data with one or multiple trained machine learning (ML) models. In some embodiments, the ML model(s) may include large language model(s) that are prompted with natural language representations of the interaction data. The inventors have further recognized that providing a fine-tuned prompt for the LLM(s) increases the accuracy of the results generated by the LLMs. In addition, providing targeted prompts (with lesser number of tokens) rather than long prompts (with larger number of tokens) enables efficient use of memory and computer resources. To this end, the technology developed by the inventors enables generation of targeted and fine-tuned prompts corresponding to different concepts associated with the interaction data. Examples of the concepts associated with the interaction data may include, but not be limited to, a business object, an activity, an intent, and a reason associated with the interaction data.

Accordingly, some embodiments provide for techniques for generating a textual (e.g., natural language text) summary of a stream of events corresponding to interactions between a user performing a process and one or more application programs executing on a computing device. The textual summary may be generated in a bottom-up fashion whereby textual summaries may be generated (e.g., using one or more ML models, for example, one or more large language models (LLMs)) for individual interactions between the user and the application program(s), these interaction-level summaries may be used to generate higher-level textual summaries. For example, the interaction-level summaries may be processed (e.g., using one or more ML models, for example, LLM(s)) to generate step-level textual summaries for subsets interactions (e.g., each of which that may form a part or a step of the overall process) and the step-level textual summaries may be processed (e.g., using one or more ML models, for example, LLM(s)) to obtain a process-level textual summary. As another example, the interaction-level summaries may be processed (e.g., using one or more ML models, for example, LLM(s)) to generate the process-level textual summary.

In some embodiments, the techniques for generating a textual summary of a stream of events corresponding to interactions between a user performing a process and one or more application programs executing on a computing device may involve: (A) receiving information corresponding to the stream of events corresponding to the interactions between the user and the application program(s), the information comprising, for each of multiple events (e.g., some or all of) in the stream of events associated with the process, metadata associated with the event, wherein metadata for a particular event specifies values for attributes of the particular event; (B) processing, using at least one machine learning (ML) model (e.g., one or more LLMs), the metadata associated with the multiple events in the stream of events to generate multiple corresponding textual summaries of the multiple events, the processing comprising: for each particular event of the multiple events in the stream of events: (i) processing metadata associated with the particular event using the at least one ML model (e.g., a single LLM or multiple LLMs, or other types of ML models) to determine a business object, an activity, an intent, and/or a reason associated with the particular event; and (ii) generating a textual summary of the particular event from the determined business object, activity, intent, and/or reason associated with the particular event; and (C) generating, using the textual summaries of the multiple events, a textual summary of the process performed by the user through the interactions between the user and the one or more application programs executing on the computing device; and (D) outputting the textual summary of the process.

In some embodiments, when processing metadata for a particular event using the at least one ML model, the business object, the activity, the intent and the reason associated with the particular event may all be determined. However, in other embodiments, only one or some of these pieces of contextual information may be determined for the particular event (e.g., activity only, business object and activity only, etc.), as aspects of the technology described herein is not limited in this respect.

In some embodiments, the at least one ML model may be a single ML model. And this single ML model may be used to determine, for a particular event, the business object, the activity, the intent, and/or the reason associated with the particular event. For example, a single ML model (e.g., an LLM, for example, a zero-shot training LLM) may be used to process metadata for a particular event in order to determine all, some or one of the business object, the activity, the intent, and the reason associated with the particular event. That same single ML model may be used to process metadata for multiple events and determine all, some or one of the business object, the activity, the intent, and the reason associated with each of the multiple events.

Accordingly, in some embodiments, the at least one ML model consists of a single ML model; and processing the metadata associated with the particular event comprises processing the metadata associated with the particular event using the single ML model to determine the business object, the activity, the intent, and/or the reason associated with the particular event.

In other embodiments, however, multiple different ML models may be used. For example, one ML model may be used to determine the business object for a particular event while another ML model may be used to determine the activity for the particular event. As yet another example, four separate ML models may be used to determine the business object, the activity, the intent and the reason associated with the particular event. Multiple different ML models may be used to process metadata for each of multiple events in the same way.

Accordingly, in some embodiments, the at least one ML model comprises a first ML model and a second ML model different from the first ML model; and processing the metadata associated with the particular event comprises: processing the metadata associated with the particular event using the first ML model to determine the business object associated with the particular event; and processing the metadata associated with the particular event using the second ML model to determine the activity associated with the particular event.

In some embodiments, the at least one ML model comprises a third ML model different from the first and second ML models and a fourth ML model different from the first, second, and third ML model; and processing the metadata associated with the particular event comprises: processing the metadata associated with the particular event using the third ML model to determine the intent associated with the particular event; and processing the metadata associated with the particular event using the fourth ML model to determine the reason associated with the particular event.

In some embodiments, the at least one ML model comprises a large language model (LLM). For example, the LLM may be one of: Llama3, Llama 2, Mistral, GPT-3, GPT-4, Bidirectional encoder representations from transformers (BERT), Orca, or any other suitable large language model, as aspects of the technology described herein are not limited in this respect.

In some embodiments, the at least one ML model comprises a large language model; and processing metadata associated with the particular event using the at least one ML model comprises prompting the large language model with a natural language representation of the metadata associated with the particular event. Examples of such prompts are provided herein.

As described herein, the metadata processed by the at least one ML model includes values of attributes associated with a particular event, where such values may be extracted using the ML-based metadata extraction techniques described herein including with reference to FIGS. 2A-B, 3-5, 6A-6B, and 7. Examples of such attributes are provided herein. For example, in some embodiments, the stream of events comprises a first event corresponding to an interaction between the user and the one or more application programs executing on the computing device, and the information corresponding to the stream of events comprises first metadata associated with the first event, and the first metadata comprises values for one or more attributes selected from the group consisting of: a name of the application program, a title of an application program screen of the application program with which the user interacted during the first event, an identifier of the user interface element of the application program screen with which the user interacted, a type of the user interface element of the application program screen with which the user interacted, one or more identifiers for one or more user interface elements of the application program screen with which the user did not interact, a duration of the interaction, and one or more textual phrases and/or sentences appearing on the application program screen.

In some embodiments, the textual summary of the particular event comprises a natural language summary of the particular event and the textual summary of the process comprises a natural language summary of the process.

The textual summary of the process may be generated from textual summaries of one or more events. For example, in some embodiments, generating the textual summary of the process comprises: (a) grouping two or more events in the multiple events into a step (e.g., by using a large language model); (b) generating a textual summary of the step using the textual summaries of the two or more events; and (c) generating the textual summary of the process using the textual summary of the step.

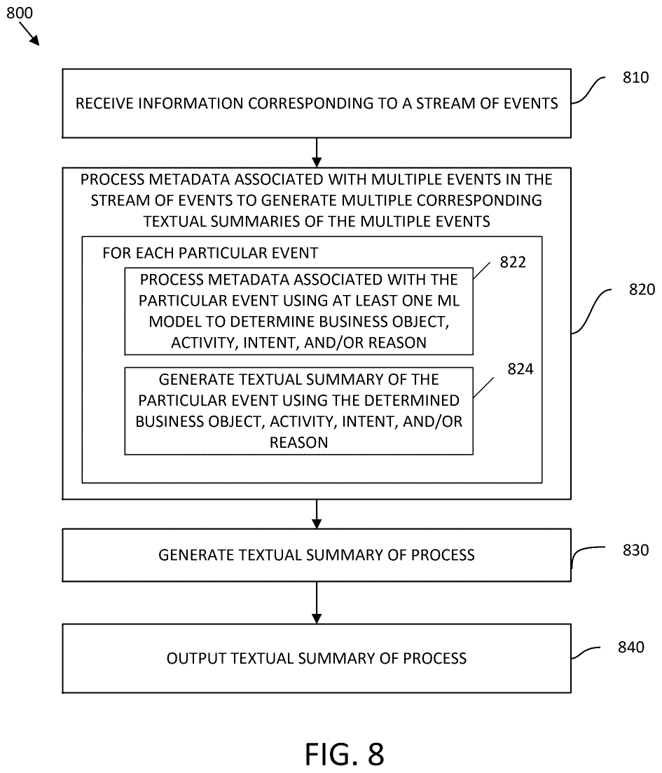

FIG. 8 is a flowchart of an illustrative method 800 for generating textual summaries of a stream of events corresponding to interactions between a user performing a process and one or more application programs executing on a computing device, in accordance with some embodiments of the technology described herein. At least some of the acts of method 800 may be performed by any suitable computing device or devices, and, for example, may be performed by one or more of the computing devices 102 and/or central controller 104 shown in process tracking system 100 of FIG. 1A

In act 810, information corresponding to a stream of events may be received. The information corresponding to a stream of events may correspond to interactions between a user and one or more application programs executing on computing device 102. The information may include, for each of multiple events in the stream of events associated with a process, metadata associated with the event, where the metadata for a particular event specifies values for attributes of the particular event. In some embodiments, the information may be collected from a single user or a user part of a team of users whose computer interactions are being captured and analyzed to generate textual summaries of the processes being performed by the user and/or team of users. Examples of metadata that may be collected for each event include, but are not limited to:
Application (e.g., the name of an application program, such as an operating system (e.g., Microsoft Windows, Mac OS, Linux) application, a web application, or a mobile application)
Screen Title (e.g., the title appearing on an application program screen such as the name of the tab in a web browser, the name of a file open in an application, etc.)
Element Identifier(s) (e.g., identifier(s) of user interface element(s) of the application program screen with which the user interacted and/or identifier(s) for user interface element(s) of the application program screen with which the user did not interact)
Element Type (e.g., the type of a user interface element of the application program screen with which the user interacted, such as “button”, “input”, “dropdown” etc.)
Element Name (e.g., the name of a user interface element of the application program screen with which the user interacted such as a name of a button, label of input, etc.)
Duration of the interaction
One or more textual phrases and/or sentences appearing on the application program screen (e.g., subject and body of emails in an email application (e.g., Outlook); content of a spreadsheet or document, such as, a list of special words that are colored, italicized, bolded or highlighted, in the spreadsheet or document application (e.g., Excel, Word, Adobe reader); text displayed on the screen of a mainframe application, etc.)

The metadata may be obtained by performing the ML-based metadata extraction techniques described herein including with reference to FIGS. 2A-B, 3-5, 6A-6B, and 7.

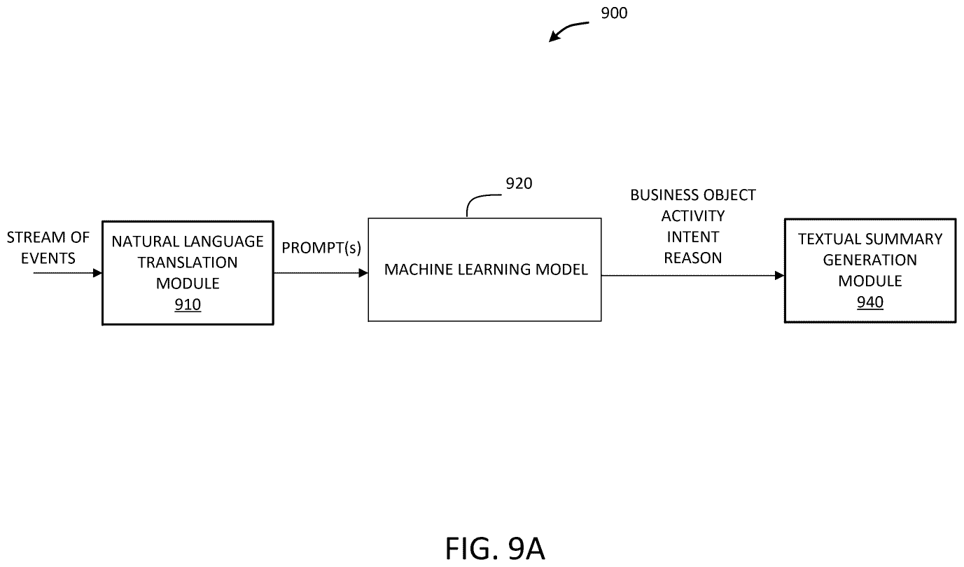

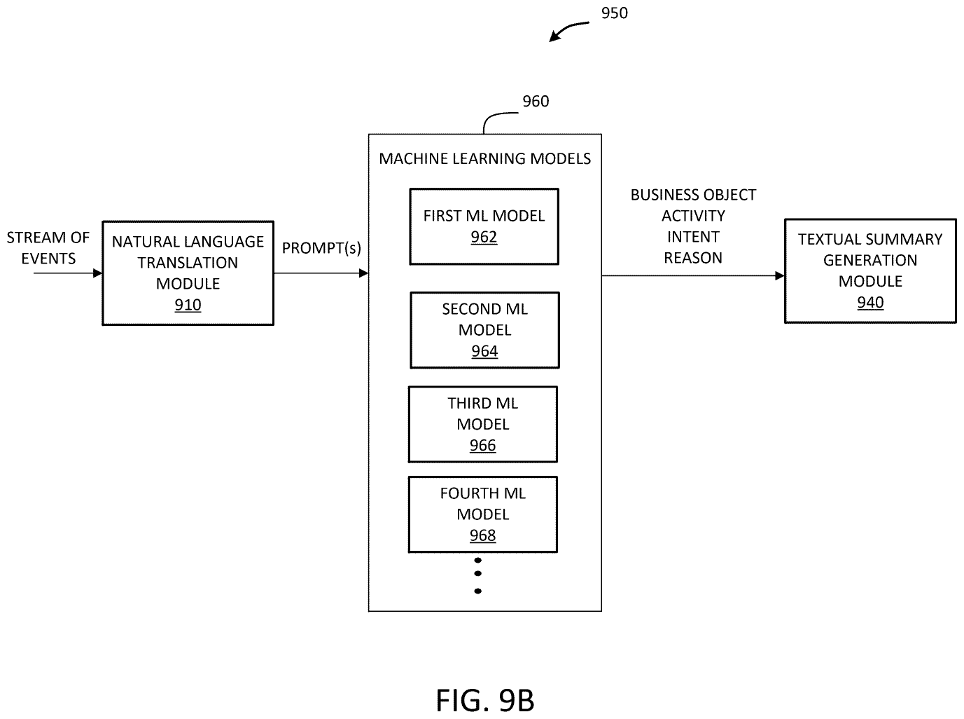

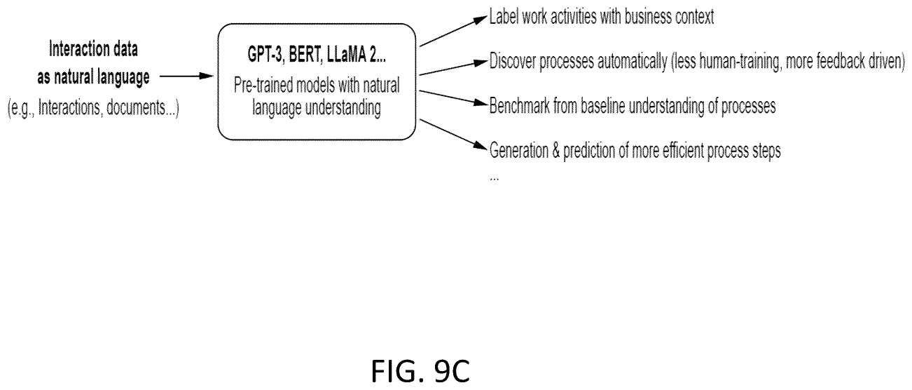

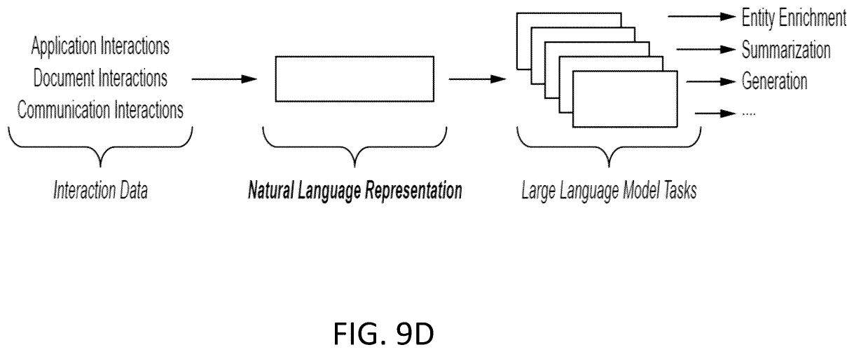

Method 800 then proceeds to act 820, where metadata associated with the multiple events in the stream of events is processed using at least one machine learning (ML) model to generate a textual summary for each of the multiple events. In some embodiments, the metadata may be translated into a natural language representation and the natural language representation of the metadata may be processed to generate the textual summaries of the multiple events. To this end, in some embodiments, process discovery module 101 may include a natural language translation module 910, as shown in FIGS. 9A and 9B, that receives information corresponding to a stream of events and translates metadata associated with multiple events in the stream of events associated with a process to a natural language representation of the metadata. In some embodiments, the at least one ML model may include at least one large language model (LLM). One or more prompts for the at least LLM one model may be generated from the natural language representation of the metadata and provided as inputs to the at least one LLM model in furtherance of generating the textual summaries.

As shown in FIG. 8, act 820 includes acts 822 and 824, both of which are performed for each of multiple events in the stream of events. At act 822, metadata associated with a particular event of the multiple events is processed using the ML model(s) to determine values of one or more entities (e.g., business object, activity, intent, and reason). In turn, these entity values may be used to create a textual summary for the particular event. For example, the metadata associated with the particular event may be processed to obtain various entity values for the particular event and these values may form or may be used to form different portions of the textual summary for the event.

In some embodiments, the at least one ML model consists of a single ML model (e.g., ML model 920 shown in FIG. 9A), and the metadata associated with the particular event is processed using the single ML model to determine the values for the business object, activity, intent, and/or reason entities for the particular event. This same single ML model may be used to process metadata for multiple events in the stream of events (not just a single event). The single ML model may be of any suitable type. For example, the single ML model may be a large language model. Examples of LLMs are provided herein. In other embodiments, the ML model may be another type of model, for example, a text generation model based on a bi-directional transformer (e.g., BERT). Examples of such models are provided herein.

In some embodiments, the at least one ML model includes different ML models 960 (e.g., as shown in diagram 950 of FIG. 9B), each of which is used to process metadata associated with the particular event to determine values of different entities (e.g., from among the business object, the activity, the intent, and the reason) for the particular event. For example, a first ML model 962 may be used to process metadata associated with the particular event to determine the business object associated with the particular event (i.e., to determine the value of the business object entity for the event), a second ML model 964 may be used to process metadata associated with the particular event to determine the activity associated with the particular event (i.e., to determine the value of the activity entity for the event), a third ML model 966 may be used to process metadata associated with the particular event to determine the intent associated with the particular event (i.e., to determine the value of the intent entity for the event), and a fourth ML model 968 may be used to process metadata associated with the particular event to determine the reason associated with the particular event (i.e., to determine the value of the reason entity for the event).

Each of the different ML models 960 may be of any suitable type. For example, one or more of the different ML models may be LLMs. As one example, the ML model 962 may be an LLM fine-tuned (e.g., through further training or few-shot prompting) to determine business objects from metadata, while the ML model 964 may be fine-tuned to determine the activity associated with metadata. As yet another example, one or more of the models 960 may be fine-tuned to perform a specific task (e.g., determining business object or activity), while one or more other models 960 may be used without fine-tuning, for example, with zero-shot prompting. Other ML models maybe used, for example, graphical models (e.g., hidden Markov models, Markov random fields, Bayesian networks), random forests, decision trees, gradient boosted decision trees, and neural networks (NNs).

A large language model (LLM) is a generative ML model that generates textual output in response to an input prompt. For example, an LLM may process an input prompt comprising metadata for an event (e.g., metadata that comprises attribute-value pairs) and generates a textual output for the event. An LLM may be a deep neural network model trained to generate textual output in response to the input prompt. The LLM may have a transformer-based architecture.

Examples of LLMs include Generative Pre-trained Transformers (GPTs) (e.g., GPT. 3.0, GPT-3.5, GPT-4), Large Language Model Meta AI (LLaMA) models (e.g., LLama 2, LLama 3, 3.2, etc.), Bidirectional Encoder Representations from Transformers (BERT) models, and Robustly Optimized BERT Approach (ROBERTA) models, Mistral AI models, and Orca models. Each such model may have billions, tens of billions, or hundreds of billions of parameters (e.g., 1-50 billion parameters, 50-100 billion parameters, 100-500 billion parameters, or 500 billion-10 trillion parameters). When executing, an LLM may receive an input prompt (e.g., a prompt constructed using metadata for an event), convert the input prompt into a numeric representation (e.g., by embedding), and process that numeric representation using the billions of parameter values part of the LLM to generate the output text.

Thus, in some embodiments, processing metadata associated with a particular event to determine a business object, activity, intent, and/or reason may involve prompting an LLM with a textual representation of the metadata associated with the particular event to have it provide such a determination as its output. The prompts may be zero-shot prompts (prompts that do not provide any examples of what the output is to look like) or few-shot prompts (prompts that provide one or a small number of examples of what the output is to look like). The LLM may be used as is without further being trained or may be fine-tuned by being further trained with specific examples of interaction data and associated entity values.

An example of a zero-shot prompt for an LLM to generate a possible name of a business object is:
Can you give me the most likely form that these fields belong to? PO Number, Issue Date, Vendor Information, Buyer Information, Shipping Address, Billing Address, Item Description, Quantity, Unit Price, Total Price, Subtotal, Tax, Shipping and Handling, Total Amount, Payment Terms, Delivery Date, Special Instructions, Terms and Conditions, Authorized Signature, Approval Status. Just give me the name.

In this example, the prompt is constructed from metadata that includes field names and/or values associated with user interface element(s) of the application UI screen with which the user interacted and the user interface elements(s) of the application UI screen with which the user did not interact. The LLM (e.g., LLama 2) may generate the following response:
Yes, based on your list of fields, here is the most likely form that they belong to: Purchase Order Form.

Based on the LLM's response, “Purchase Order” may be determined as the business object the user is working with, and this may be used to generate a textual summary of the event.

As another example, the following is a prompt for an LLM to identify an activity:
There is screen called {Screen Title} The screen is an app called {Application}. The screen has the following fields—{Field Names and/or Values} that appear to be a {Business Object}. The user interacted with the following fields {Field Names}. In no more than five words, what is the activity performed on this screen?

In this example, the prompt is also constructed from metadata including field names and/or values associated with user interface element(s) of the application that the user was using as well as an indication of the specific UI elements with which the user interacted. Each of the variables in brackets is filled in based on the metadata when generating the prompt. Notably, one of the variables is the {Business Object} entity, whose value in the prompt may be a value determined by using an LLM (as described above) or another type of ML model. Thus, the results of determining a business object may be used (e.g., as part of a prompt to an LLM) to determine an activity. Similarly, the results of determining a business object and/or activity may be used (e.g., as part of a prompt to an LLM) to determine an intent for the activity and/or the reason for performing the activity. Returning to the example prompt in the preceding paragraph, the LLM (e.g., LLama 2) may generate the following response:
The user was updating a claim on a purchase order by editing the destination of the claim.

As another example, the following is a prompt for an LLM to identify an intent:
There is screen called {Screen Title} The screen is an app called {Application}. The screen has the following fields—{Field Names and/or Values} that appear to be a {Business Object}. The user interacted with the following fields {Field Names}. In no more than five words, what is the overall business intent of the activity in this screen?

In this example, the prompt is also constructed from metadata including field names and/or values associated with user interface element(s) of the application that the user was using as well as an indication of the specific UI elements with which the user interacted. Each of the variables in brackets may be filled in based on the metadata when generating the prompt. Note that the Business Object is also identified in the prompt and the value of this variable may be determined from the output of an LLM (the same or different one that this prompt will be provided to). The generated response may be:
To track business operations in shipping and logistics.

As another example, the following is a prompt for an LLM to identify a reason:
A user performed an activity in a process which was ‘Searching with item number’, can you tell me why the user performed this activity?

As is clear, the above prompt includes the determined activity associated with the event. The inventors have recognized that it is helpful to include activity information associated with multiple events to determine a meaningful reason for a particular event. For example, a user may have performed a particular activity followed by a sequence of one or more other activities. In this case, prompting the LLM with, in addition to the determined activity associated with the particular event, the activities associated with one or more events following the particular event, may result in a more meaningful reason being provided as a response.

An example of such a prompt is:
A user performed an activity in a process which was ‘Searching with item number’, can you tell me why the user performed this activity in the context of the following activities that followed it: “Extraction item price and packaging information”, “Entering invoice number”, “Adding items in the invoice”, Updating invoice amount”, and “Fixing an invoice due date.”

An LLM processing the above prompt may generate the following response:
The step is required to search for the item and fetch the latest price of the item from the item master list document.

In some embodiments, additional information (e.g., in addition to the metadata/activity associated with the particular event) may be used to prompt the LLM to obtain a meaningful reason associated with the particular event. Examples of such additional information may include, but not be limited to: metadata associated with events that occurred before the particular event, metadata associated with events that occurred after the particular event, the determined business object, activity, and/or intent associated with the previous and/or following events, the industry associated with the events (e.g., Healthcare), and any other process information, such as interactions taking place while the user performs a particular process (e.g., a purchase order process).

Referring back to FIG. 8, in act 824, a textual summary of the particular event may be generated from the determined business object, activity, intent, and/or reason associated with the particular event. Putting the responses together from the preceding examples produces the following example textual summary:
The user was updating a claim on a purchase order by editing the destination of the claim, as part of work related to ordering and purchasing goods or services to manage and track business operations in shipping and logistics.

Method 800 then proceeds to act 830, where textual summaries of multiple events in the stream of events associated with the process are generated and the textual summaries of the multiple events are used to generate a textual summary of the process. In some embodiments, generating the textual summary of the process may include grouping two or more events in the multiple events into a step, generating a textual summary of the step using the textual summaries of the two or more events, and generating the textual summary of the process using the textual summary of the step. In some embodiments, process discovery module 101 may include a textual summary generation module 940, as shown in FIGS. 9A and 9B, that is configured to generate textual summaries of events, steps, and/or processes.

In act 840, the generated textual summary of the process is output. In some embodiments, the generated textual summary may be displayed via a user interface.

In some embodiments, when the machine learning model used is an LLM, the input to be provided to the LLMs described herein may first be converted to natural language as shown in FIG. 9C. Then, the LLMs may be prompted using the natural language representation, as shown in FIG. 9D, to produce outcomes such as labelling work activities and generating textual summaries of events, steps, and/or processes performed by the user. As an example, an LLM may be prompted to determine an intent associated with an event. The metadata associated with the event may be translated to a natural language representation for the prompt as follows:
“Can you tell me the intent behind a user interaction with the desktop application ‘SAP’ on a screen ‘Create Purchase Order’ with the field name ‘Submit’ which is of type ‘Button’?”

Although this example prompt is a prompt to an LLM for determining an intent associated with a single event, the LLM may be prompted to determine an intent associated with multiple events. For this, the prompt provided to the LLM may include natural language metadata associated with multiple events in lists or comma separated format.

It should be appreciated that the techniques described herein can be used for various purposes, including but not limited to:
Providing a high-level description (e.g., a textual summary) with business context of what interactions were performed by a user.
Providing high-level descriptions of how different ways of the same process are performed.
Summarizing differences in how a team conducts a process differently.
Automatically labeling a repetitive pattern that users perform as likely to be a particular activity with a name (e.g., “Creating a purchase order.”).
Describing the intent of a document based on its content.
Providing what processes a document is typically performed in.
Benchmarking the efficiency of how a team performs the process compared to other teams.
Identifying bottlenecks with business context when the process is typically performed (e.g., “The slowness of application X is causing purchase order creation delays.”)
Generating more than descriptions, for example, generating content itself, such as, generating an ideal document for a particular use case (e.g., generate an ideal invoice form for a process); generating a more efficient way of performing steps in a process that the team can perform; generating code that can perform a set of business activities that were captured; generating support tickets when issues are experienced; and generating consultant-like recommendations to improve the process or activities being performed.

The techniques described herein can provide teams with a better understanding of their activities and how to improve them. For example, the users can be provided with real-time notifications when they are about to make a mistake while performing a process/activity.

As is clear from the foregoing, a variety of different types of ML models may be used for generating textual summaries of interaction events, steps, and processes. In some embodiments, one or more LLMs may be used. Each such LLM may be used without further training and may be prompted with zero-shot or few-shot prompts. In other embodiments, any one of the LLMs being used may be further trained using additional training data (e.g., not just through few-shot prompting). For example, such training data may include examples of interaction metadata (e.g., attribute-value pairs examples of which are provided herein) and corresponding entity values (e.g., values of business object, activity, intent, and reason entities). Such training data may be generated by: having users perform a process, deriving metadata from the data recorded as the process is performed, and labelling the derived metadata with corresponding entity values.

### Other Implementation Details

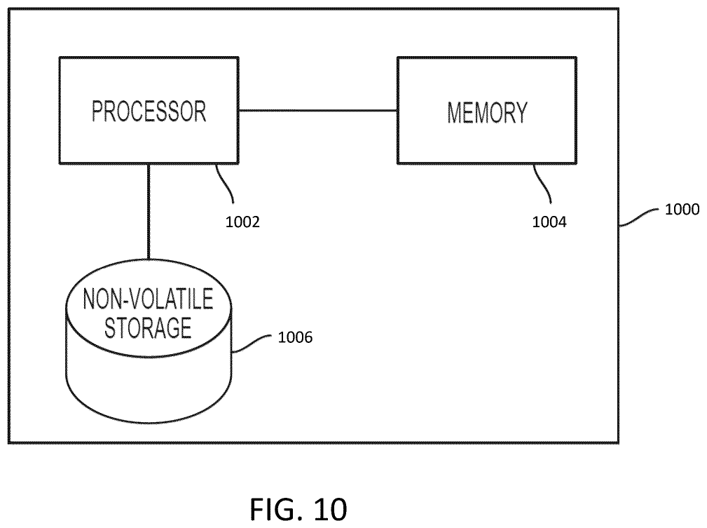

An illustrative implementation of a computer system 1000 that may be used in connection with any of the embodiments of the disclosure provided herein is shown in FIG. 10. For example, any of the computing devices described above may be implemented as computing system 1000. The computer system 1000 may include one or more computer hardware processors 1002 and one or more articles of manufacture that comprise non-transitory computer-readable storage media (e.g., memory 1004 and one or more non-volatile storage devices 1006). The processor 1002 (s) may control writing data to and reading data from the memory 1004 and the non-volatile storage device(s) 1006 in any suitable manner. To perform any of the functionality described herein, the processor(s) 1002 may execute one or more processor-executable instructions stored in one or more non-transitory computer-readable storage media (e.g., the memory 1004), which may serve as non-transitory computer-readable storage media storing processor-executable instructions for execution by the processor(s) 1002.

The terms “program” or “software” are used herein in a generic sense to refer to any type of computer code or set of processor-executable instructions that may be employed to program a computer or other processor to implement various aspects of embodiments as described above. Additionally, according to one aspect, one or more computer programs that when executed perform methods of the disclosure provided herein need not reside on a single computer or processor but may be distributed in a modular fashion among different computers or processors to implement various aspects of the disclosure provided herein.

Processor-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed.

Also, data structures may be stored in one or more non-transitory computer-readable storage media in any suitable form. For simplicity of illustration, data structures may be shown to have fields that are related through location in the data structure. Such relationships may likewise be achieved by assigning storage for the fields with locations in a non-transitory computer-readable medium that convey relationship between the fields. However, any suitable mechanism may be used to establish relationships among information in fields of a data structure, including through the use of pointers, tags or other mechanisms that establish relationships among data elements.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, for example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

Use of ordinal terms such as “first,” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having a same name (but for use of the ordinal term). The phraseology and terminology used herein is for the purpose of description and should not be regarded as limiting. The use of “including,” “comprising,” “having,” “containing,” “involving,” and variations thereof, is meant to encompass the items listed thereafter and additional items.

Having described several embodiments of the techniques described herein in detail, various modifications, and improvements will readily occur to those skilled in the art. Such modifications and improvements are intended to be within the spirit and scope of the disclosure. Accordingly, the foregoing description is by way of example only, and is not intended as limiting. The techniques are limited only as defined by the following claims and the equivalents thereto.

1. A method of gathering information about a process being performed by a user of a computing device, the computing device having application programs and separate monitoring software installed thereon, the user performing the process by performing a sequence of actions via a respective sequence of application user interface (UI) screens, each of the application UI screens being generated by a respective one of the application programs, the method comprising:
using at least one computer hardware processor of the computing device to perform:
(A) capturing screenshots of at least some application UI screens in the sequence of application UI screens to obtain a sequence of application screenshots including a first application screenshot, while the user is performing the process by performing the sequence of actions via the respective sequence application screens;
(B) processing the sequence of application screenshots using multiple different trained machine learning (ML) models to extract a corresponding sequence of application UI screen metadata including first application UI screen metadata extracted from the first application screenshot, the multiple different trained ML models including an object detection model and a text recognition model, the processing comprising:
generating a first image from the first application screenshot;
detecting, using the object detection model, objects in the first image corresponding to graphical user interface (GUI) elements visible in the first application screenshot; and
recognizing, using the text recognition model, text visible in at least some of the GUI elements visible in the first application screenshot,
wherein the first application UI screen metadata comprises metadata about one or more of the GUI elements visible in the first application screenshot;
(C) using the sequence of application UI screen metadata to generate a representation of the process being performed by the user; and
(D) storing the representation of the process on the computing device and/or transmitting the representation of the process to another device different from the computing device.

2. The method of claim 1, wherein:
the first application screenshot comprises a first GUI element,
detecting, using the object detection model, objects in the first image corresponding to GUI elements visible in the first application screenshot comprises determining location of a first bounding box of the first GUI element in the first application screenshot, and
recognizing, using the text recognition model, text visible in at least some of the GUI elements visible in the first application screenshot comprises recognizing first text visible in the first GUI element.

3. The method of claim 1, wherein:
the first application screenshot was generated by a first application program,
the sequence of application screenshots includes a second application screenshot also generated by the first application program, and
processing the sequence of application screenshots comprises:
caching, in volatile memory of the computing device, text strings recognized using the text recognition model in association with information about the corresponding GUI elements visible in the first application screenshot; and
accessing at least some of the text strings cached in the volatile memory of the computing device instead of using the text recognition model to recognize text in at least some GUI elements visible in the second application screenshot that correspond to the GUI elements visible in the first application screenshot.

4. The method of claim 3,
wherein the information about the corresponding GUI elements visible in the first application screenshot indicates locations of bounding boxes of the corresponding GUI elements, and
wherein caching the text strings is performed by caching the text strings using hashes of pixels in the bounding boxes as keys to the cache.

5. The method of claim 4, wherein:
the first application screenshot comprises a first GUI element,
detecting, using the object detection model, objects in the first image corresponding to GUI elements visible in the first application screenshot comprises determining location of a first bounding box of the first GUI element in the first application screenshot,
recognizing, using the text recognition model, text visible in at least some of the GUI elements visible in the first application screenshot comprises recognizing first text visible in the first GUI element, and
wherein caching the text strings comprises caching, in the volatile memory of the computing device, the first text string using a hash of pixels in the first bounding box as a key.

6. The method of claim 4, further comprising: flushing the cached text strings from the volatile memory when the first application program closes or restarts or according to a schedule.

7. The method of claim 1, further comprising:
prior to recognizing, using the text recognition model, text visible in the at least some of the GUI elements visible in the first application screenshot,
using a text detection technique to identify the at least some of the GUI elements, from among the GUI elements visible in the first application screenshot for which objects were detected using the object detection model.

8. The method of claim 1, further comprising:
accessing a configuration specifying a resource utilization policy applicable to the computing device, the resource utilization policy specifying limits on utilization of one or more computing device resources during performance of acts (A) and (B) by software executing on the computing device; and
performing (A) and (B) in accordance with the limits specified by the resource utilization policy.

9. The method of claim 1, further comprising:
removing or masking personally-identifiable information (PII) in the sequence of application UI screen metadata prior to performing (C) and/or (D).

10. The method of claim 1, wherein (B) further comprises:
organizing at least some of the objects detected using the object detection model into an object hierarchy; and
including the object hierarchy as part of the first application UI screen metadata.

11. The method of claim 1, wherein the object detection model is a trained convolutional neural network that is trained to detect objects in screenshots and the method further comprising:
obtaining training data comprising a plurality of annotated screenshots of at least some the application UI screens; and
using the training data to train the object detection model.

12. The method of claim 1, wherein the text recognition model comprises an optical character recognition model for recognizing text strings visible in the at least some of the GUI elements.

13. The method of claim 1, wherein generating the first image from the first application screenshot comprises:
processing the first image using one or more pre-processing techniques, the one or more pre-processing techniques comprising one or more of gray scaling, sharpening, and color inversion techniques, wherein processing the first image using the one or more pre-processing techniques comprises:
determining a first type of the one or more pre-processing techniques to use to process the first image based on a type of application program that generated an application UI screen for which the first application screenshot was captured.

14. The method of claim 1, wherein the GUI elements visible in the first application screenshot comprise one or more of the following: a screen title, an active tab, a tab, a horizontal key-value pair, a vertical key-value pair, an address bar, a drop-down menu, a text box, a table, a label, an overlay, a header, an icon, a check box, a radio button, and a button.

15. The method of claim 1, wherein the first application UI screen metadata comprises:
a hierarchy of the one or more of the GUI elements visible in the first application screenshot, and
for each of the one or more of the GUI elements, an element name, an element type, and an element value.

16. The method of claim 1, further comprising:
using the representation of the process to discover the process during performance of a second sequence of actions by the user via a respective second sequence of application UI screens.

17. The method of claim 1, further comprising:
generating, using the representation of the process, a visualization of at least some of the sequence of actions.

18. The method of claim 1, further comprising:
identifying an automatable task using the representation of the process; and
generating a software robot to perform the automatable task.

19. A system comprising:
a computing device having application programs and separate monitoring software installed thereon; and
at least one non-transitory computer-readable storage medium having stored therein instructions which, when executed, program the computing device to perform a method of gathering information about a process being performed by a user of a computing device, the computing device having application programs and separate monitoring software installed thereon, the user performing the process by performing a sequence of actions via a respective sequence of application user interface (UI) screens, each of the application UI screens being generated by a respective one of the application programs, the method comprising:
(A) capturing screenshots of at least some application UI screens in the sequence of application UI screens to obtain a sequence of application screenshots including a first application screenshot, while the user is performing the process by performing the sequence of actions via the respective sequence application screens;
(B) processing the sequence of application screenshots using multiple different trained machine learning (ML) models to extract a corresponding sequence of application UI screen metadata including first application UI screen metadata extracted from the first application screenshot, the multiple different trained ML models including an object detection model and a text recognition model, the processing comprising:
generating a first image from the first application screenshot;
detecting, using the object detection model, objects in the first image corresponding to graphical user interface (GUI) elements visible in the first application screenshot; and
recognizing, using the text recognition model, text visible in at least some of the GUI elements visible in the first application screenshot,
wherein the first application UI screen metadata comprises metadata about one or more of the GUI elements visible in the first application screenshot;
(C) using the sequence of application UI screen metadata to generate a representation of the process being performed by the user; and
(D) storing the representation of the process on the computing device and/or transmitting the representation of the process to another device different from the computing device.

20. At least one non-transitory computer-readable storage medium having stored therein instructions which, when executed, program a computing device to perform a method of gathering information about a process being performed by a user of a computing device, the computing device having application programs and separate monitoring software installed thereon, the user performing the process by performing a sequence of actions via a respective sequence of application user interface (UI) screens, each of the application UI screens being generated by a respective one of the application programs, the method comprising:
(A) capturing screenshots of at least some application UI screens in the sequence of application UI screens to obtain a sequence of application screenshots including a first application screenshot, while the user is performing the process by performing the sequence of actions via the respective sequence application screens;
(B) processing the sequence of application screenshots using multiple different trained machine learning (ML) models to extract a corresponding sequence of application UI screen metadata including first application UI screen metadata extracted from the first application screenshot, the multiple different trained ML models including an object detection model and a text recognition model, the processing comprising:
generating a first image from the first application screenshot;
detecting, using the object detection model, objects in the first image corresponding to graphical user interface (GUI) elements visible in the first application screenshot; and
recognizing, using the text recognition model, text visible in at least some of the GUI elements visible in the first application screenshot,
wherein the first application UI screen metadata comprises metadata about one or more of the GUI elements visible in the first application screenshot;
(C) using the sequence of application UI screen metadata to generate a representation of the process being performed by the user; and
(D) storing the representation of the process on the computing device and/or transmitting the representation of the process to another device different from the computing device.
